(19) United States
(12) Patent Application Publication
(10) Pub. No.: US 2013/0055188 A1
(43) Pub. Date: Feb. 28, 2013

(54) SEMICONDUCTOR LAYOUT SETTING DEVICE, SEMICONDUCTOR LAYOUT SETTING METHOD, AND SEMICONDUCTOR LAYOUT SETTING PROGRAM

(71) Applicant: Hideaki FUTAKATA, Kanagawa (JP)

(72) Inventor: Hideaki FUTAKATA, Kanagawa (JP)

(73) Assignee: RENESAS ELECTRONICS CORPORATION, Kanagawa (JP)

(21) Appl. No.: 13/593,192

(22) Filed: Aug. 23, 2012

(30) Foreign Application Priority Data
Aug. 24, 2011 (JP) 2011-182200

(51) Int. Cl. G06F 17/50

(52) U.S. Cl. 716/122

(57) ABSTRACT

A semiconductor device for layout has first and second power supply domains and has wiring connected to and from cells belonging to a second power supply domain. A wiring inhibited/allowed area setting unit sets an exclusive wiring inhibited area and a pass-through wiring allowed area within the first power supply domain based on a repeater wire maximum length being a maximum wire length which a repeater buffer can drive. A wiring setting unit modifies wiring based on the exclusive wiring inhibited area and the pass-through wiring allowed area. A repeater insertion unit sets a repeater buffer to be inserted on a wire according to the repeater wire maximum length. The exclusive wiring inhibited area allows wiring connecting cells within the first power supply domain and inhibits pass-through wiring. The pass-through wiring allowed area, being the first power supply domain excluding the exclusive wiring inhibited area, allows pass-through wiring.

### CROSS-REFERENCE TO RELATED APPLICATIONS

This application is based upon and claims the benefit of priority from Japanese patent application No. 2011-182200, filed on Aug. 24, 2011, the disclosure of which is incorporated herein in its entirety by reference.

### BACKGROUND

The present invention relates to a semiconductor layout setting device, a semiconductor layout setting method, and a semiconductor layout setting program and, particularly, to a semiconductor layout setting device, a semiconductor layout setting method, and a semiconductor layout setting program for a semiconductor device in which a repeater buffer is inserted on a wire.

In portable equipment such as mobile telephones today, reduction in the power consumption of a LSI (Large Scale Integration) is required to get longer battery driving time. Such equipment includes a plurality of power supplies for a LSI and conducts power control such as blocking power supply or reducing a supply voltage to an unused circuit in accordance with the operating mode of the LSI.

In the case of performing layout design of a LSI having a plurality of power supplies, the design should be made for each area divided for each power to be supplied. Therefore, layout design of such a LSI is more difficult than layout design of a LSI having a single power supply. Accordingly, a layout design method that can suppress an increase in LSI chip area and design TAT (Turn Around Time) is required.

Japanese Unexamined Patent Application Publication No. 2005-005496, which is hereinafter referred to as “Patent Literature 1”, discloses a semiconductor integrated circuit that can resolve the problem of decrease in operating speed and increase in power consumption due to multistage repeater buffers as well as avoiding unstable operation. The semiconductor integrated circuit disclosed in Patent Literature 1 is described in detail hereinbelow.

First, a typical semiconductor integrated circuit as a comparative example in Patent Literature 1 is described with reference to FIG. 28. The semiconductor integrated circuit includes a first power supply receiving area A61 to which a first power is supplied and a second power supply receiving area A62 to which a second power is supplied. The second power supply receiving area A62 is included within the first power supply receiving area A61. In the first power supply receiving area A61, blocks B61 and B62 exist with the second power supply receiving area A62 interposed therebetween.

In this configuration, a case is studied in which there is a signal output from the block B61 and input to the block B62 and the two blocks are distant from each other. A connection between those blocks needs to be made through a repeater buffer for speeding up. In this case, it is desired to place a line that linearly connects the block B61 and the block B62 and place a repeater buffer on the line. However, a power different from a power to the block B61 and the block B62 is supplied to the second power supply receiving area A62. There is thus a possibility that a power with a desired voltage is not supplied to the repeater buffer placed within the second power supply receiving area A62 and that the repeater buffer does not perform a desired operation. Therefore, the block B61 and the block B62 need to be connected through a repeater buffer that is placed within the first power supply receiving area A61, which is within the same power supply system. Accordingly, the block B61 and the block B62 are connected through repeater buffers RB61 to RB63 and lines L61 to L64 that are arranged to detour around the second power supply receiving area A62.

However, in this connection (connection through the repeater buffers RB61 to RB63 and the lines L61 to L64), the number of stages of repeater buffers increases compared to when a line connects linearly from the block B61 to the block B62, which hinders the achievement of higher speed and lower power consumption.

The semiconductor integrated circuit disclosed in Patent Literature 1 is described hereinafter with reference to FIG. 29. The semiconductor integrated circuit has at least two power supply systems and includes a first power supply receiving area A1 to which a first power is supplied, a second power supply receiving area A2 which is included within the first power supply receiving area A1 and to which a second power is supplied, and a third power supply receiving area A3 which is included within the second power supply receiving area A2, to which the first power is supplied, and which has a signal relay circuit. A plurality of circuits in the first power supply receiving area are connected via a repeater buffer RB in the third power supply receiving area A3.

In this configuration, the repeater buffer RB operates normally because the first power is supplied thereto. Further, because a roundabout line is not needed as shown in FIG. 29, it is possible to prevent an increase in the number of stages of repeater buffers and allow achievement of higher speed and lower power consumption.

### SUMMARY

However, the semiconductor integrated device disclosed in Patent Literature 1 has a problem that the LSI chip area is large. In the semiconductor integrated device shown in FIG. 29, it is necessary to place the third power supply receiving area A3 within the second power supply receiving area A2, which enlarges the second power supply receiving area A2. This results in an increase in LSI chip area.

Further, it is necessary to supply a power to the third power supply receiving area A3 placed within the second power supply receiving area A2. It is thus necessary to lay a power supply line such as L3 in FIG. 30. Accordingly, a line resource for a signal net within the second power supply receiving area A2 decreases. In order to ensure the line resource within the second power supply receiving area A2, it is necessary to enlarge the second power supply receiving area A2, which results in an increase in LSI chip area.

The overview of a layout technique for a semiconductor integrated device using a typical automatic placement and routing tool and its problem are described hereinbelow.

FIG. 31 is an example in which a net (signal lines connecting terminals and connections between terminals) that passes through a power supply receiving area (which is referred to also as a power supply domain in the following description) is configured using a typical automatic placement and routing tool.

A power supply domain A maintains the state where power supply is always ON, which means that a power is always supplied to the power supply domain A. On the other hand, a power is not supplied to a power supply domain B (OFF) when an internal circuit does not operate. The automatic placement and routing tool creates routes R1 to R3, for example, as a net to connect primitive cells P2 and P3 and selects one among them (determines one as a net of the primitive cells P2 and P3). Then, the automatic placement and routing tool inserts a repeater buffer RB1 along the selected route.

When the route R1 is selected, the distance to pass through the power supply domain B is long. It is thus necessary to insert a repeater buffer within the power supply domain B. However, if a repeater buffer is inserted within the power supply domain B, power supply to the inserted repeater buffer is cut off when the power supply to the power supply domain B is cut off. For this reason, the repeater buffer cannot be inserted within the power supply domain B. In the case where the third power supply domain is formed within the power supply domain B and the repeater buffer is inserted within the power supply domain as described in Patent Literature 1, the LSI chip area becomes large.

A typical automatic placement and routing tool allows setting to inhibit a net to pass through different power supply domains. In the case of setting to inhibit, a net to connect to a cell belonging to the power supply domain A does not pass through the area of the power supply domain B. The automatic placement and routing tool thereby selects the route R2. However, because the route R2 detours all the way around, the line length increases to cause a large delay.

A study on the route R3 is as follows. Although the route R3 passes through the area of the power supply domain B, the distance to pass through it is short. When the distance is short enough to allow driving with one repeater buffer, it is not necessary to insert a repeater buffer in the area of the power supply domain B. Therefore, it is preferred that the automatic placement and routing tool selects the route R3 in the above example.

However, a typical automatic placement and routing tool does not make a route selection in consideration of insertion of a repeater buffer. Therefore, the automatic placement and routing tool does not always select the route R3 and selects the route R1 or the route R2 in some cases. When the route R1 or R2 is selected, a user, who is a designer, needs to manually change the net layout. This causes an increase in TAT (Turn Around Time) at the time of design.

Note that a typical automatic placement and routing tool can set a wiring inhibited area for a partial area within the power supply domain. This is described in detail with reference to FIG. 32. A partial area B1 within the power supply domain B is set as a wiring inhibited area according to specification by a user. A wire W1 that connects the primitive cells P2 and P3 is thereby laid like the route R3. However, in this case, the wiring inhibit is applied also to the partial are B1. Thus, a wire W2 that connects primitive cells P4 and P5 cannot be laid by the setting of the wiring inhibited area.

Therefore, according to the above-described technique (the technique disclosed in Patent Literature 1, a typical automatic placement and routing tool), the layout of a semiconductor integrated circuit in which a repeater buffer is inserted appropriately and which avoids an increase in chip area cannot be attained.

A semiconductor layout setting device, a semiconductor layout setting method, and a semiconductor layout setting program according to one aspect of the present invention are to decide placement of wiring on the basis of a repeater wire maximum length being a maximum wire length which a repeater buffer can drive in a layout of a semiconductor device having first and second power supply domains.

According to the aspect of the present invention, the distance which the wiring passes through each power supply domain and the wiring coordinate positions are set based on the repeater wire maximum length, thereby avoiding generation of an area for repeater buffers. It is thus possible to reduce the chip area and avoid the malfunction of a repeater buffer caused by a difference in power supply domain.

According to the present invention, it is possible to provide a semiconductor layout setting device, a semiconductor layout setting method, and a semiconductor layout setting program that can set the layout of a semiconductor integrated circuit in which a repeater buffer is inserted appropriately and which avoids an increase in chip area.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a semiconductor layout setting device according to a first embodiment;

FIG. 2 is a block diagram showing a configuration of the semiconductor layout setting device according to the first embodiment;

FIG. 3 is a diagram showing an example of setting of an exclusive wiring inhibited area and a pass-through wiring allowed area by the semiconductor layout setting device according to the first embodiment;

FIG. 4 is a flowchart showing an operation of the semiconductor layout setting device according to the first embodiment;

FIG. 5 is a flowchart showing a flow of a process of a wiring inhibited/allowed area setting unit according to the first embodiment;

FIGS. 6A-6D are diagrams showing a specific example of setting of an exclusive wiring inhibited area by the wiring inhibited/allowed area setting unit according to the first embodiment;

FIG. 7 is diagram showing a specific example of setting of an exclusive wiring inhibited area by the wiring inhibited/allowed area setting unit according to the first embodiment;

FIG. 8 is a flowchart showing a flow of a wiring modification process by a wiring setting unit according to the first embodiment;

FIGS. 9A-9D are conceptual diagrams showing an example of operation of the semiconductor layout setting device according to the first embodiment;

FIGS. 10A-10C are conceptual diagrams showing an example of operation of the semiconductor layout setting device according to the first embodiment;

FIGS. 11A and 11B are diagrams showing in detail insertion of a repeater buffer by a repeater insertion unit according to the first embodiment;

FIG. 12 is a diagram showing a case where there is a wire with a longer length than the maximum length of a repeater line within the pass-through wiring allowed area;

FIGS. 13A-13C are diagrams showing a method of solving the problem shown in FIG. 12;

FIGS. 14A and 14B are diagrams showing that the problem shown in FIG. 12 cannot be solved by a typical automatic placement and routing tool when a repeater buffer is inserted in the exclusive wiring inhibited area;

FIG. 15 is a diagram showing a method of solving the problem shown in FIG. 12;

FIG. 16 is a diagram showing layout information generated by the semiconductor layout setting device according to the first embodiment;

FIG. 17 is a flowchart showing a process of a wiring inhibited/allowed area setting unit according to a second embodiment;

FIGS. 18A-18D are conceptual diagrams showing a process of the wiring inhibited/allowed area setting unit according to the second embodiment;

FIG. 19 is a diagram showing an example of a cutout area set by the wiring inhibited/allowed area setting unit according to the second embodiment;

FIGS. 20A-20D are conceptual diagrams showing a process of the wiring inhibited/allowed area setting unit according to the second embodiment;

FIG. 21 is a diagram showing layout information set by the semiconductor layout setting device according to the first embodiment;

FIG. 22 is a diagram showing layout information set by the semiconductor layout setting device according to the second embodiment;

FIGS. 23A-23C are diagrams showing a method of setting a cutout area set by the wiring inhibited/allowed area setting unit according to the second embodiment;

FIG. 24 is a block diagram showing another configuration example of a semiconductor layout setting device according to an embodiment of the present invention;

FIG. 25 is a block diagram showing another configuration example of a semiconductor layout setting device according to an embodiment of the present invention;

FIG. 26 is a block diagram showing a configuration example of a system according to an embodiment of the present invention;

FIG. 27 is a block diagram showing a configuration example of a computer device according to an embodiment of the present invention;

FIG. 28 is a block diagram showing a configuration of a typical semiconductor integrated circuit;

FIG. 29 is a block diagram showing a configuration of a semiconductor integrated circuit disclosed in Patent Literature 1;

FIG. 30 is a block diagram showing a configuration of the semiconductor integrated circuit disclosed in Patent Literature 1;

FIG. 31 is a diagram showing layout information generated by a typical automatic placement and routing tool; and

FIG. 32 is a diagram showing a layout of a semiconductor device by a typical automatic placement and routing tool.

### DETAILED DESCRIPTION

### First Embodiment

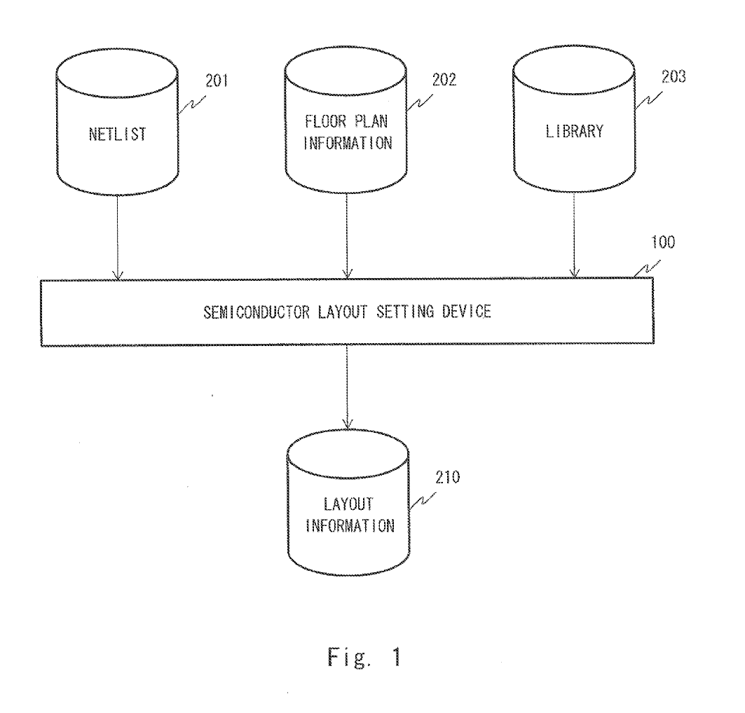

Embodiments of the present invention are described hereinafter with reference to the drawings. First, an overall configuration of a semiconductor layout setting device according to this embodiment is described with reference to FIG. 1. FIG. 1 is a block diagram showing an input/output configuration of a semiconductor layout setting device 100.

A netlist 201, floor plan information 202, and library 203 are input to the semiconductor layout setting device 100. The netlist 201 is information about connectivity of primitive cells. The primitive cell is a generic term for a circuit from which or to which a line is connected, a terminal and the like. The floor plan information 202 is information containing the chip size of a LSI to be designed and coordinates information of a power supply domain. The library 203 is information containing delay information of primitive cells, macro cells and the like. The library 203 contains information about the maximum load capacitance which a repeater buffer can drive.

The semiconductor layout setting device 100 generates layout information 210 on the basis of the netlist 201, the floor plan information 202 and the library 203, and outputs the layout information 210 to a given storage device or the like. The layout information 210 contains the placement of power supply domains, the placement of primitive cells, information about a wire connecting the primitive cells, placement information of a repeater buffer placed on a wire and the like.

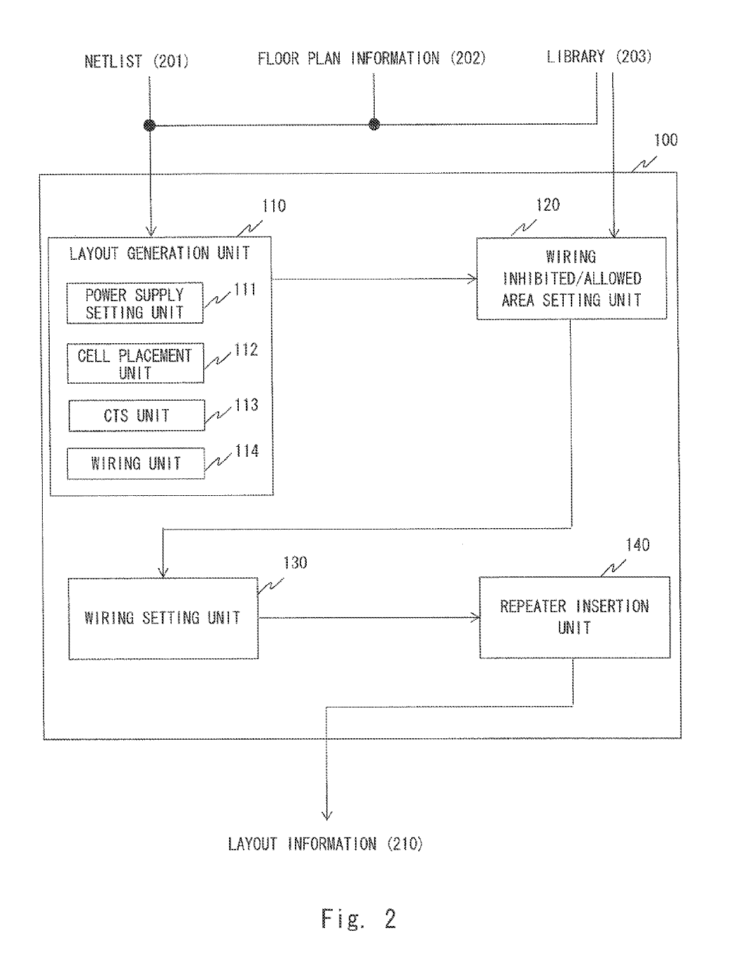

FIG. 2 shows a detailed configuration of the semiconductor layout setting device 100. The semiconductor layout setting device 100 includes a layout generation unit 110, a wiring inhibited/allowed area setting unit 120, a wiring setting unit 130, and a repeater insertion unit 140. The layout generation unit 110 includes a power supply setting unit 111, a cell placement unit 112, a CTS (Clock Tree Synthesis) unit 113, and a wiring unit 114.

The netlist 201, the floor plan information 202 and the library 203 are input to the layout generation unit 110. The layout generation unit 110 designs the layout of a LSI (generates layout information that specifies the layout) on the basis of the floor plan information 202. Processing of each component of the layout generation unit 110 is described hereinafter.

The power supply setting unit 111 in the layout generation unit 110 sets the placement of power supply domains or the like by reference to the floor plan information 202. The cell placement unit 112 sets the position of primitive cells. The CTS unit 113 builds a tree of a clock signal based on the input information (the netlist 201, the floor plan information 202 and the library 203) and sets the built tree. The wiring unit 114 sets wiring for connecting the primitive cells by reference to the netlist 201.

The layout generation unit 110 supplies the layout information specifying the placement of primitive cells and wiring to the wiring inhibited/allowed area setting unit 120. Note that each processing by the layout generation unit 110 is processing that is implemented by the existing software (the above-described placement and routing tool).

The wiring inhibited/allowed area setting unit 120 sets an exclusive wiring inhibited area to the supplied layout information by reference to the floor plan information 202 and the library 203. Specifically, the wiring inhibited/allowed area setting unit 120 extracts coordinate information of each power supply domain from the floor plan information 202, and extracts information of the maximum load capacitance which a repeater buffer can drive and a load capacitance per unit wire length from the library 203. The wiring inhibited/allowed area setting unit 120 calculates an exclusive wiring inhibited area from the extracted coordinate information of each power supply domain, maximum load capacitance which a repeater buffer can drive, and load capacitance per unit wire length. The exclusive wiring inhibited area is an area defined as follows.

(1) The exclusive wiring inhibited area belongs to one power supply domain (in no case a certain exclusive wiring inhibited area belongs to a plurality of power supply domains).

(2) Wiring between primitive cells placed in the power supply domain to which the exclusive wiring inhibited area belongs is allowed, and the other wiring is inhibited.

In other words, the exclusive wiring inhibited area is an area in which wiring passing through the area is inhibited.

The wiring inhibited/allowed area setting unit 120 further sets a pass-through wiring allowed area at the same time as setting the exclusive wiring inhibited area. The pass-through wiring allowed area is an area defined as follows.

(1) The pass-through wiring allowed area is an area in which the exclusive wiring inhibited area is excluded from the power supply domain to which the exclusive wiring inhibited area belongs.

(2) The pass-through wiring allowed area is an area in which pass-through wiring is allowed as a general rule.

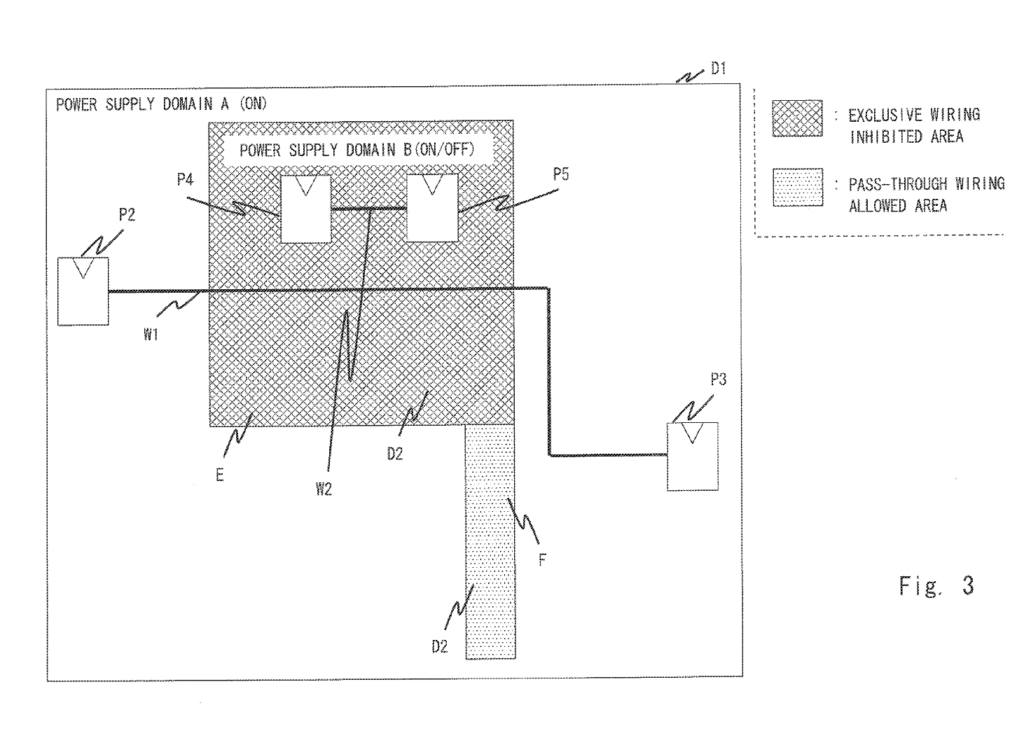

FIG. 3 is a diagram showing an example of setting of the exclusive wiring inhibited area and the pass-through wiring allowed area. As shown in FIG. 3, an area of a power supply domain A (D1) and an area of a power supply domain B (D2) are set. The power supply domain A maintains the state where power supply is always ON, which means that a power is always supplied to the power supply domain A. On the other hand, a power to the power supply domain B is cut off (OFF) when an internal circuit does not operate. Primitive cells P2 and P3 are placed within the area of the power supply domain A (D1). Primitive cells P4 and P5 are placed within the area of the power supply domain B (D2). A wire W1 is a wire that connects the primitive cells P2 and P3. A wire W2 is a wire that connects the primitive cells P4 and P5.

An exclusive wiring inhibited area E and a pass-through wiring allowed area F are set within the area of the power supply domain B (D2). In the exclusive wiring inhibited area E, whether wiring is allowable or not is determined according to the above definition. Specifically, the wire W2 that connects the primitive cells P4 and P5 both belonging to the power supply domain B is allowed. On the other hand, the wire W1 that connects the primitive cells P2 and P3 not belonging to the power supply domain B is inhibited. The wire W3 that is inhibited is rewired (wiring route is modified) by the wiring setting unit 130, which is described later.

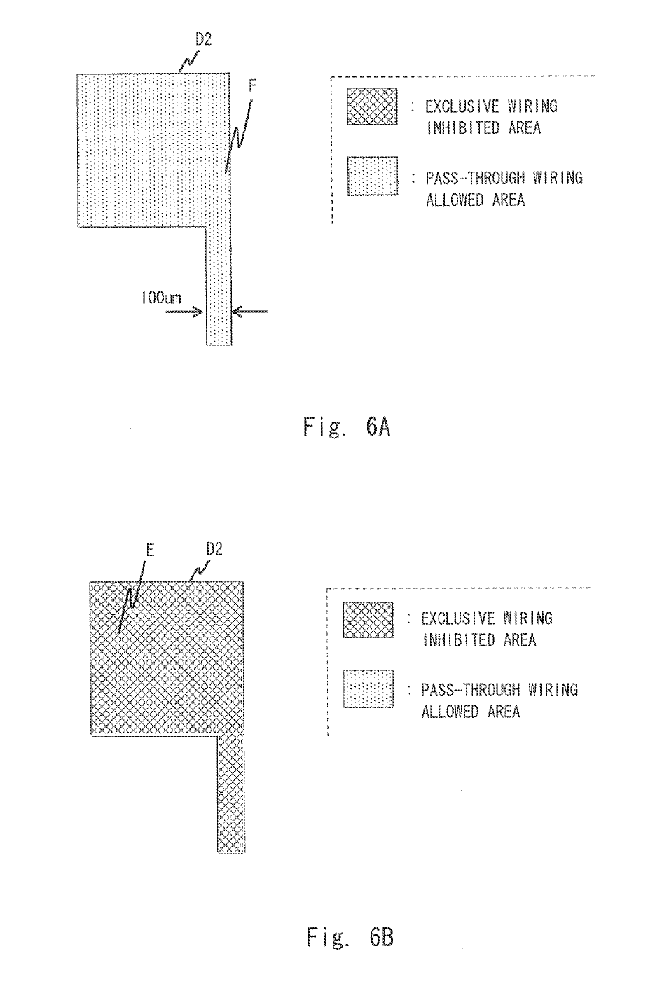

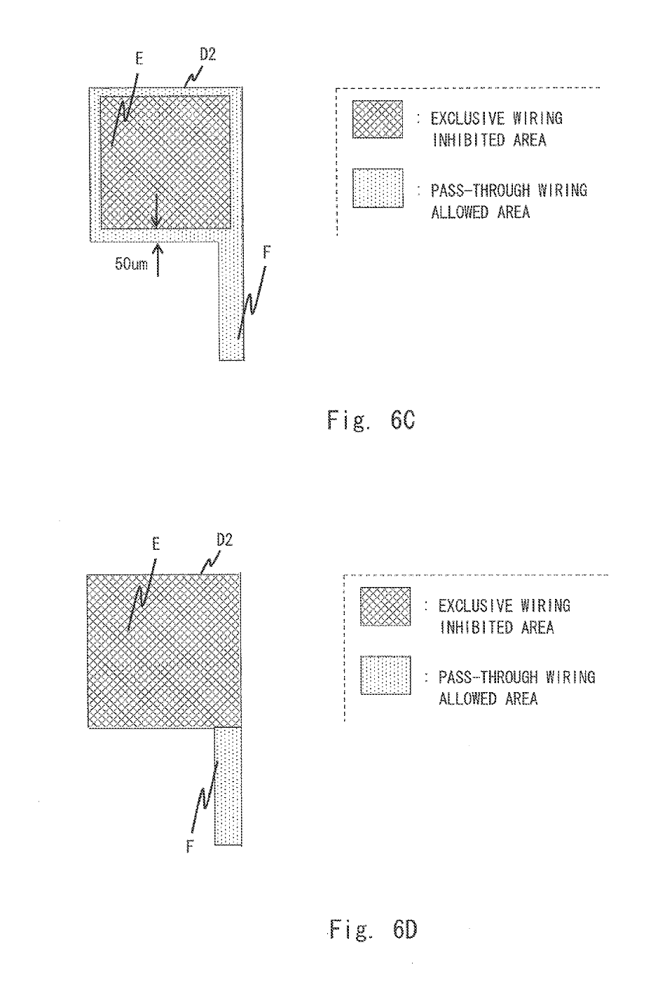

Referring back to FIG. 2, the wiring inhibited/allowed area setting unit 120 supplies the layout information that sets the exclusive wiring inhibited area and the pass-through wiring allowed area to the wiring setting unit 130. Note that a method of setting the exclusive wiring inhibited area and the pass-through wiring allowed area by the wiring inhibited/allowed area setting unit 120 is described in detail later with reference to FIGS. 6A-6D and the like.

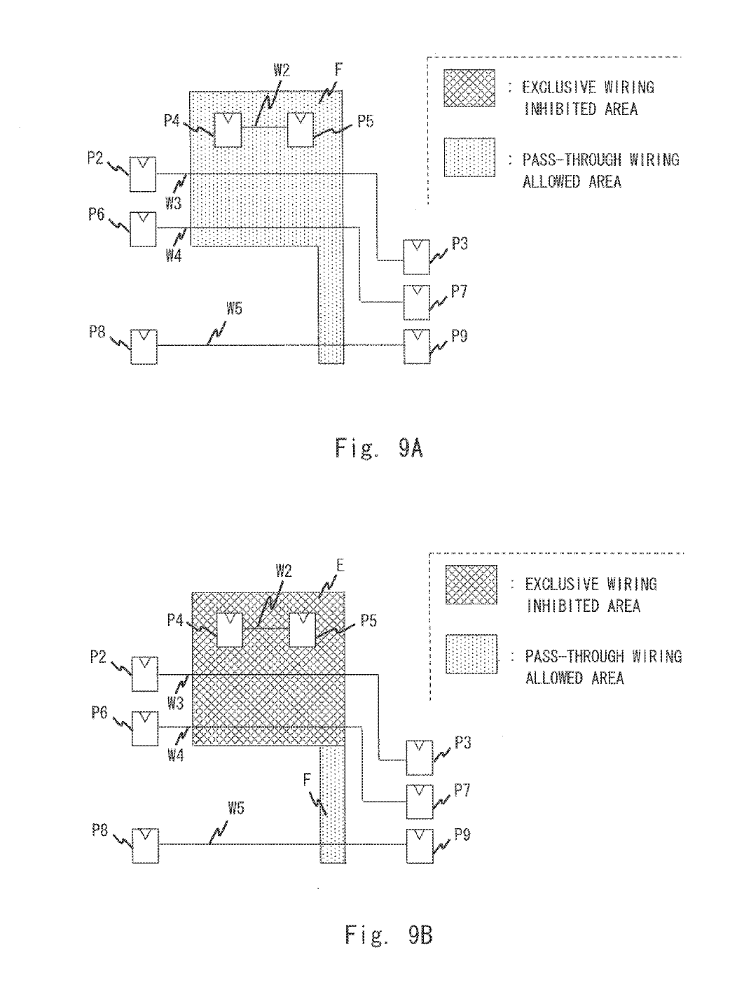

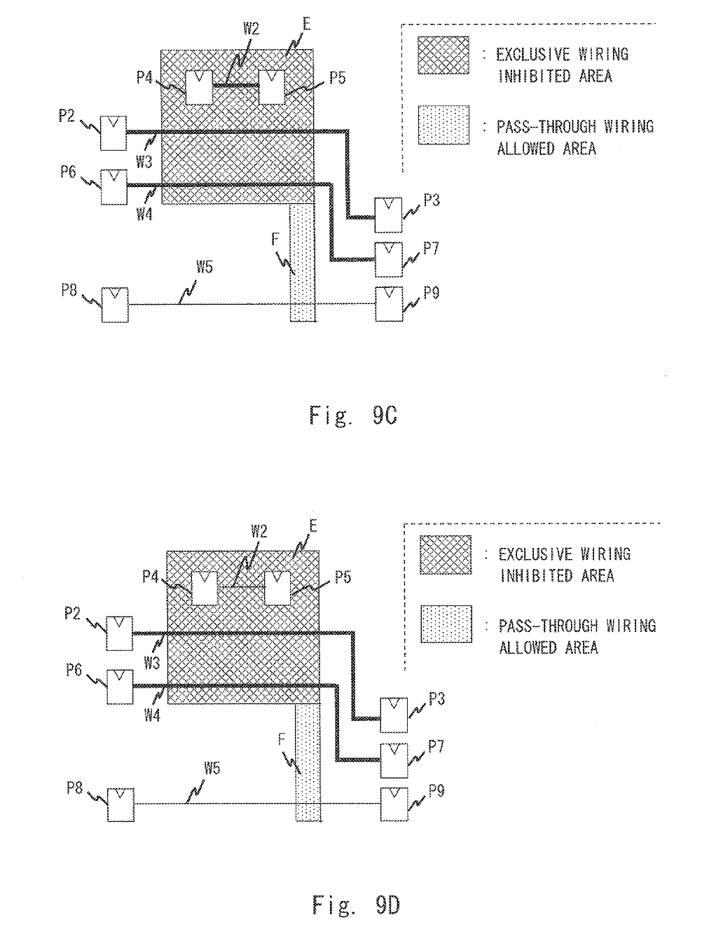

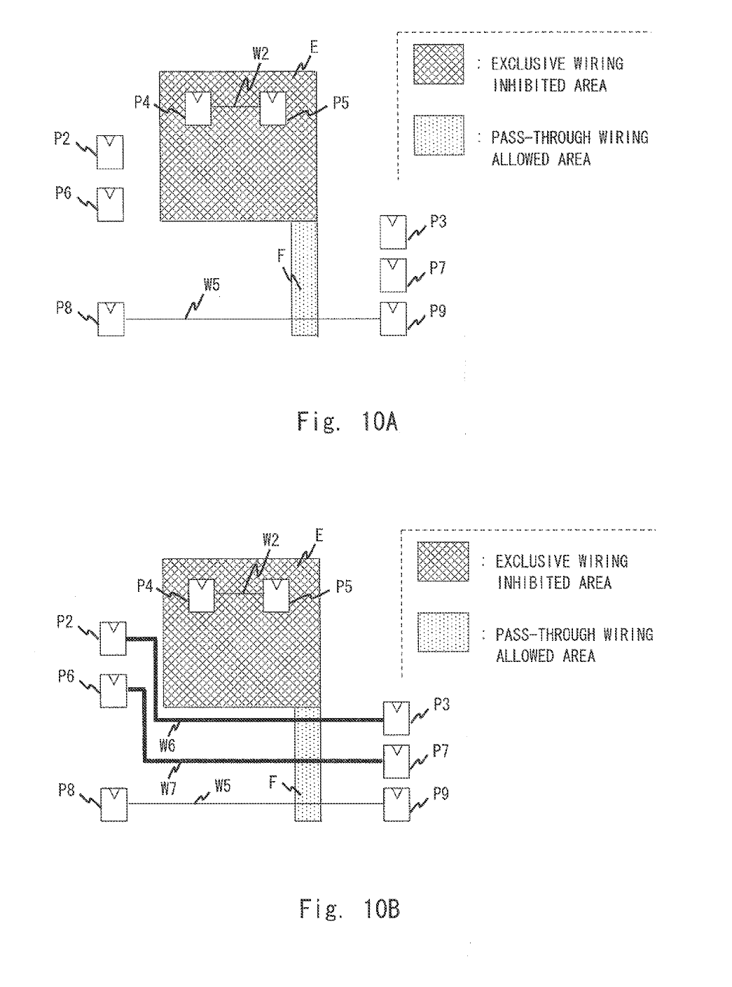

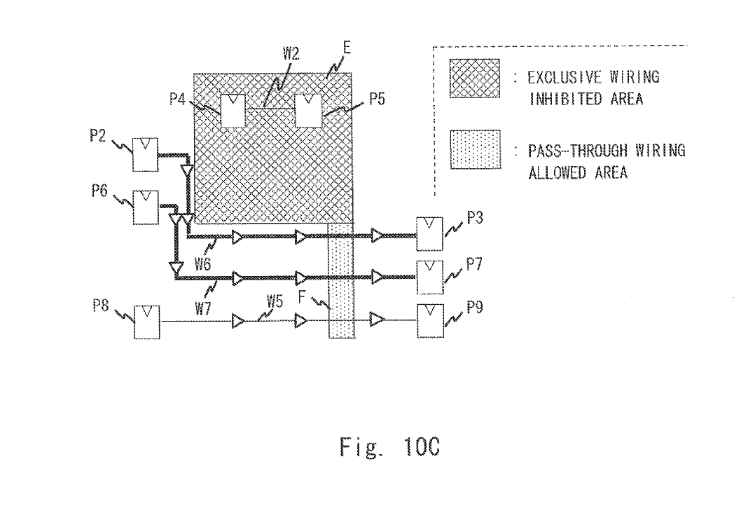

The wiring setting unit 130 detects a wire that passes through the exclusive wiring inhibited area and sets a wire as an alternative to that wire. The operation of the wiring setting unit 130 is described in detail later with reference to FIGS. 9, 10 and the like.

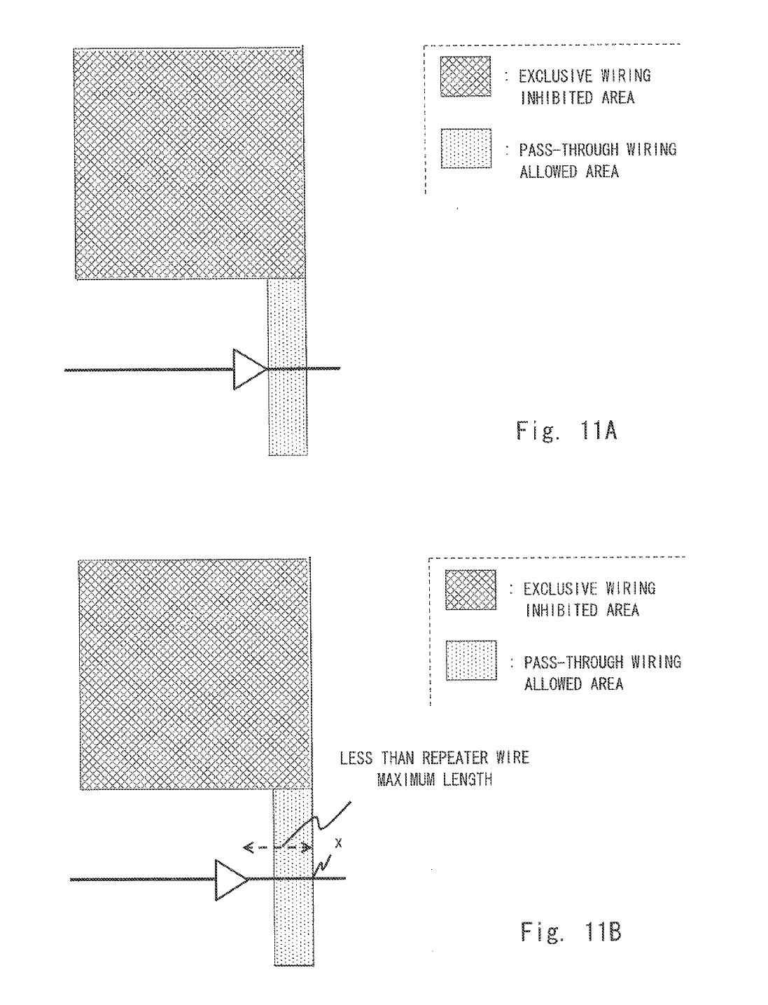

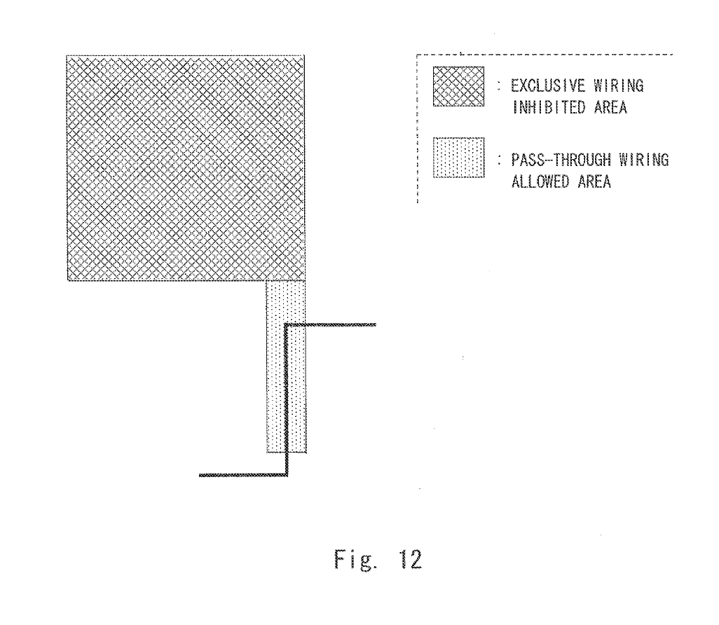

The repeater insertion unit 140 sets information of a repeater buffer to be inserted on a wire. The repeater insertion unit 140 extracts the maximum load capacitance which a repeater buffer can drive from the library 203, calculates the maximum wire length which a repeater buffer can drive (which is referred to hereinafter as the repeater wire maximum length) from the information, and determines a position to insert a repeater buffer based on the repeater wire maximum length. The repeater insertion unit 140 supplies the layout information that sets information about a repeater buffer (the layout information 210) to a given storage device or the like. The processing of the repeater insertion unit 140 is described in detail later with reference to FIGS. 11A-11B.

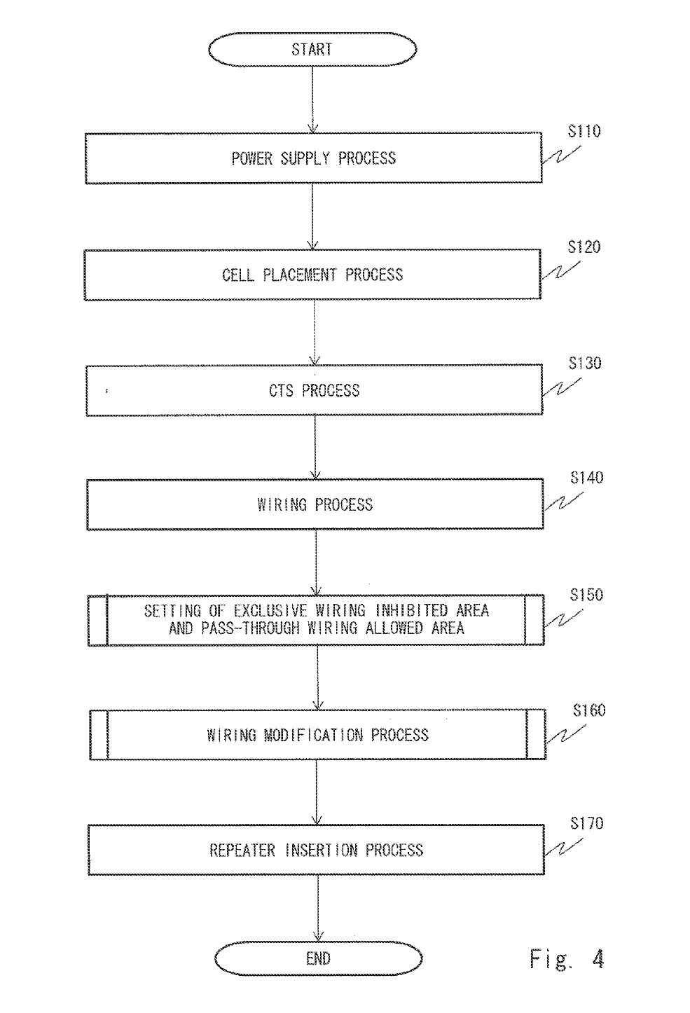

The operation of the semiconductor layout setting device 100 according to this embodiment is further described with reference to FIG. 4. FIG. 4 is a flowchart showing the operation of the semiconductor layout setting device 100 according to this embodiment.

The power supply setting unit 111 sets the placement of power supply domains or the like by reference to the floor plan information 202 (S110). The cell placement unit 112 sets the placement of primitive cells (S120). The CTS unit 113 builds a tree of a clock signal and sets the built tree (S130). The wiring unit 114 sets wiring for connecting the primitive cells by reference to the netlist 201 (S140).

The wiring inhibited/allowed area setting unit 120 sets the exclusive wiring inhibited area and the pass-through wiring allowed area by reference to the floor plan information 202 and the library 203 (S150). Then, the wiring setting unit 130 detects a wire that passes through the exclusive wiring inhibited area and sets a wire as an alternative to the wire (S160). The repeater insertion unit 140 sets information about a repeater buffer to be inserted on a wire (S170).

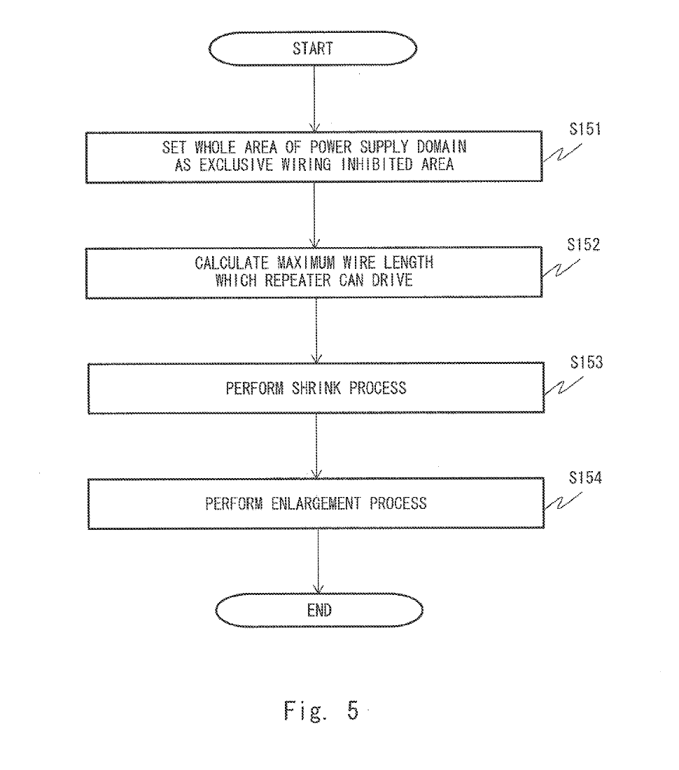

The semiconductor layout setting device 100 according to this embodiment has its feature in the processes of S150 to S170. Those processes are described hereinafter in detail. First, the setting of the exclusive wiring inhibited area and the pass-through wiring allowed area (S150) is described in detail with reference to FIG. 5. FIG. 5 is a flowchart showing the details of the setting of the exclusive wiring inhibited area and the pass-through wiring allowed area.

First, the wiring inhibited/allowed area setting unit 120 sets the whole area of each power supply domain as the exclusive wiring inhibited area (S151). Next, the wiring inhibited/allowed area setting unit 120 calculates the repeater wire maximum length (S152). The repeater wire maximum length is calculated by using the following equation. Note that the maximum load capacitance which a repeater buffer can drive [F] and the load capacitance per unit wire length [F/m] are defined by the library 203.

Repeater wire maximum length [m]=Maximum load capacitance which a repeater buffer can drive [F]/Load capacitance per unit wire length [F/m]

Then, the wiring inhibited/allowed area setting unit 120 performs processing to shrink the exclusive wiring inhibited area that has been set in S151 (shrinkage processing) (S153). The shrinkage processing is processing to reduce the area by the equal distance from each side of the outline of the exclusive wiring inhibited area.

This is described in detail later with reference to FIGS. 6A-6D. The amount of shrinkage (the distance from each side of the outline of the area) is ½ of the repeater wire maximum length calculated by the above equation.

Further, the wiring inhibited/allowed area setting unit 120 performs processing to enlarge the exclusive wiring inhibited area (enlargement processing) after the shrinkage processing (S154). The enlargement processing is processing to increase the area by the equal distance from each side of the outline of the exclusive wiring inhibited area. This is described in detail later with reference to FIGS. 6A-6D. The amount of enlargement (the distance from each side of the outline of the area) is ½ of the repeater wire maximum length calculated by the above equation. By the processing of S154, the wiring inhibited/allowed area setting unit 120 determines the exclusive wiring inhibited area.

A specific example of the setting of the exclusive wiring inhibited area by the wiring inhibited/allowed area setting unit 120 is described hereinafter, taking the area of the power supply domain B (D2) shown in FIGS. 6A-6D as an example. The area of the power supply domain B (D2) has a vertically-oriented rectangular area with a width of 100 μm.

FIG. 6A is a diagram showing the area of the power supply domain B (D2) before the setting of the exclusive wiring inhibited area by the wiring inhibited/allowed area setting unit 120. The wiring inhibited/allowed area setting unit 120 sets the whole area of the power supply domain B (D2) as the exclusive wiring inhibited area (S151). FIG. 6B is a diagram showing the state where the whole area of the power supply domain B (D2) is set as the exclusive wiring inhibited area E.

The wiring inhibited/allowed area setting unit 120 calculates the repeater wire maximum length using the above equation. In the description, it is assumed that the repeater wire maximum length is 100 μm.

The wiring inhibited/allowed area setting unit 120 performs the shrinkage processing on the exclusive wiring inhibited area (S153). FIG. 6C is a diagram showing the exclusive wiring inhibited area E and the area of the power supply domain B (D2) after the shrinkage processing. As shown in FIG. 6C, processing to reduce the area by 50 μm in parallel from each side of the outline of the exclusive wiring inhibited area E is performed as the shrinkage processing.

Then, the wiring inhibited/allowed area setting unit 120 performs the enlargement processing on the exclusive wiring inhibited area (S153). FIG. 6D is a diagram showing the exclusive wiring inhibited area E and the area of the power supply domain B (D2) after the enlargement processing. As shown in FIG. 6D, processing to enlarge the area by 50 μm in parallel from each side of the outline of the exclusive wiring inhibited area E is performed as the enlargement processing.

The wiring inhibited/allowed area setting unit 120 sets the area in which the exclusive wiring inhibited area E after the enlargement processing is excluded from the area of the power supply domain B (D2) as the pass-through wiring allowed area F.

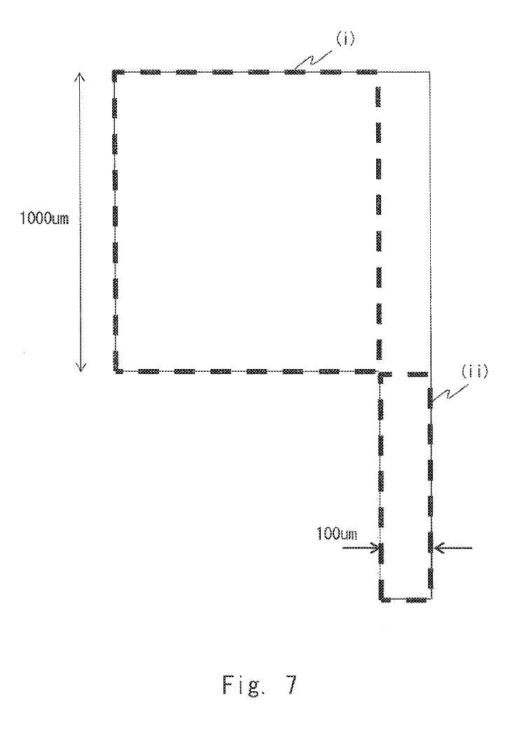

Although the wiring inhibited/allowed area setting unit 120 sets the exclusive wiring inhibited area by the enlargement processing and the shrinkage processing, it is not limited thereto, and the exclusive wiring inhibited area may be set by another method. Another example of a method of setting the exclusive wiring inhibited area is described with reference to FIG. 7.

The wiring inhibited/allowed area setting unit 120 first sets the whole area of a power supply domain as the exclusive wiring inhibited area. The wiring inhibited/allowed area setting unit 120 excludes a protrusion area in which the distance between the opposed sides is the repeater wire maximum length or less, among protrusion areas of the power supply domain, from the exclusive wiring inhibited area (sets the area as the pass-through wiring allowed area).

FIG. 7 is a diagram showing the area of the power supply domain B (D2) like FIGS. 6A-6D. The area of the power supply domain B (D2) includes a protrusion area (i) in which the distance between the opposed sides is 1000 μm and a protrusion area (ii) in which the distance between the opposed sides is 100 μm or less. The wiring inhibited/allowed area setting unit 120 excludes the protrusion area (ii) in which the distance between the opposed sides is 100 μm or less from the exclusive wiring inhibited area. In other words, the wiring inhibited/allowed area setting unit 120 sets the area in which the protrusion area (ii) is excluded from the area of the power supply domain B (D2) as the exclusive wiring inhibited area. The protrusion area (ii) serves as the pass-through wiring allowed area.

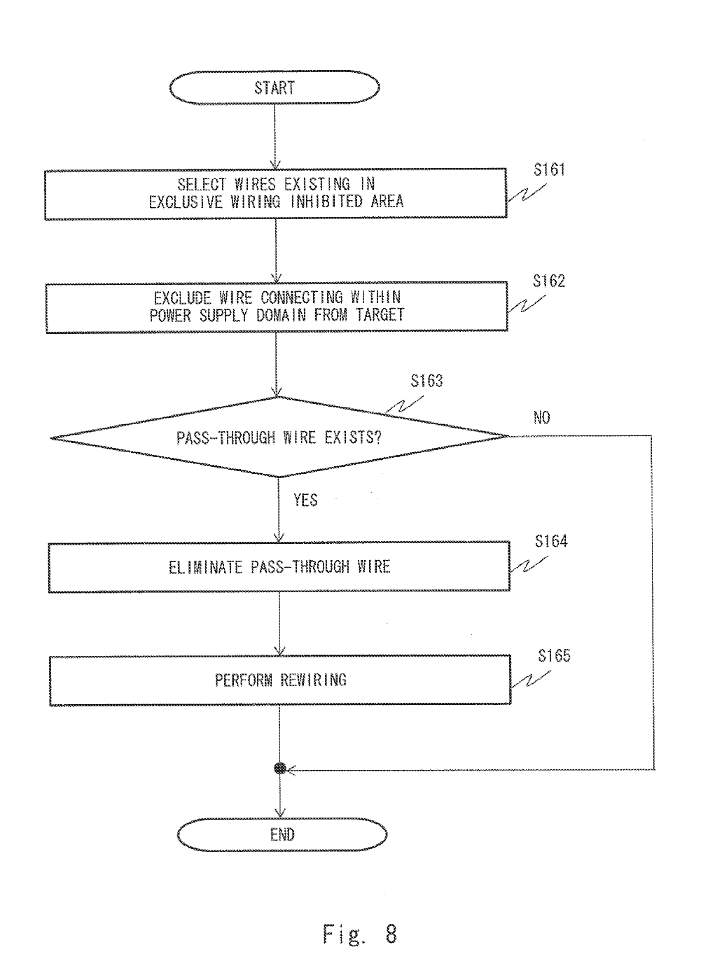

The wiring modification process (S160) by the wiring setting unit 130 is described in detail hereinbelow. FIG. 8 is a flowchart showing the detail of the wiring modification process (S160).

The wiring setting unit 130 selects all of the wires existing in the exclusive wiring inhibited area as a target of rewiring (S161). The wiring setting unit 130 then excludes a wire connecting cells within the same power supply domain among the wires selected in S161 from the target of rewiring (S162).

The wiring setting unit 130 determines whether there is a wire passing through the exclusive wiring inhibited area (S163). In other words, the wiring setting unit 130 determines whether a wire as a target of rewiring is selected after the processing of S162.

When there is no wire passing through the exclusive wiring inhibited area (No in S163), the wiring setting unit 130 ends the process.

When, on the other hand, there is a wire passing through the exclusive wiring inhibited area (Yes in S163), the wiring setting unit 130 eliminates the wire passing through the exclusive wiring inhibited area (S164). The wiring setting unit 130 then sets a new wire that connects cells which have been connected by the eliminated wire (S165).

A specific example of the above-described processes of S161 to S165 is described hereinafter with reference to FIGS. 9 and 10. Note that the placement of power supply domains and primitive cells in FIGS. 9 and 10 is the same as that of FIG. 3 except that primitive cells P6 to P9 are placed in addition. Note that the illustration of the area of the power supply domain A (D1) is omitted.

FIG. 9A is a diagram showing a layout generated by the layout generation unit 110. FIG. 9B is a diagram showing the setting of the exclusive wiring inhibited area E and the pass-through wiring allowed area F by the wiring inhibited/allowed area setting unit 120.

The wiring setting unit 130 selects all of the wires existing in the exclusive wiring inhibited area E as a target of rewiring. FIG. 9C is a diagram showing the selected wires (W2, W3 and W4) by heavy lines. The wiring setting unit 130 then excludes a wire (W2) connecting cells within the same power supply domain among the selected wires (W2, W3 and W4) from the target of rewiring. FIG. 9D is a diagram showing the state where the wire W2 is excluded from a target of selection and the wires W3 and W4 remain selected.

The wiring setting unit 130 eliminates the selected wires. FIG. 10A is a diagram showing the state where the selected wires W3 and W4 are eliminated. The wiring setting unit 130 then sets wires as an alternative to the eliminated wires. FIG. 10B is a diagram showing the state where a wire W6 as an alternative to the wire W3 and a wire W7 as an alternative to the wire W4 are set.

The repeater insertion unit 140 inserts repeater buffers on the wires after the modification process by the wiring setting unit 130. FIG. 10C is a diagram showing the state where repeater buffers are inserted on each wire.

A process to insert repeater buffers by the repeater insertion unit 140 is described in detail with reference to FIGS. 11A-11B. As shown in FIG. 11A, the repeater insertion unit 140 first inserts a repeater buffer at the boundary between the pass-through wiring allowed area and another power supply domain. The repeater insertion unit 140 then inserts other repeater buffers with respect to the repeater buffer as a reference. The width of the pass-through wiring allowed area is the repeater wire maximum length or less. Therefore, insertion of a repeater buffer within the pass-through wiring allowed area is prevented.

Note that the repeater insertion unit 140 does not necessarily insert a repeater buffer at the boundary with the pass-through wiring allowed area within the pass-through wiring allowed area. Specifically, as shown in FIG. 11B, a repeater buffer to serve as a reference may be inserted at the position at which the length of a wire across the pass-through wiring allowed area is the repeater wire maximum length or less from a point of contact between the wire and the pass-through wiring allowed area and which is outside the pass-through wiring allowed area. This prevents a repeater buffer from being inserted within the pass-through wiring allowed area.

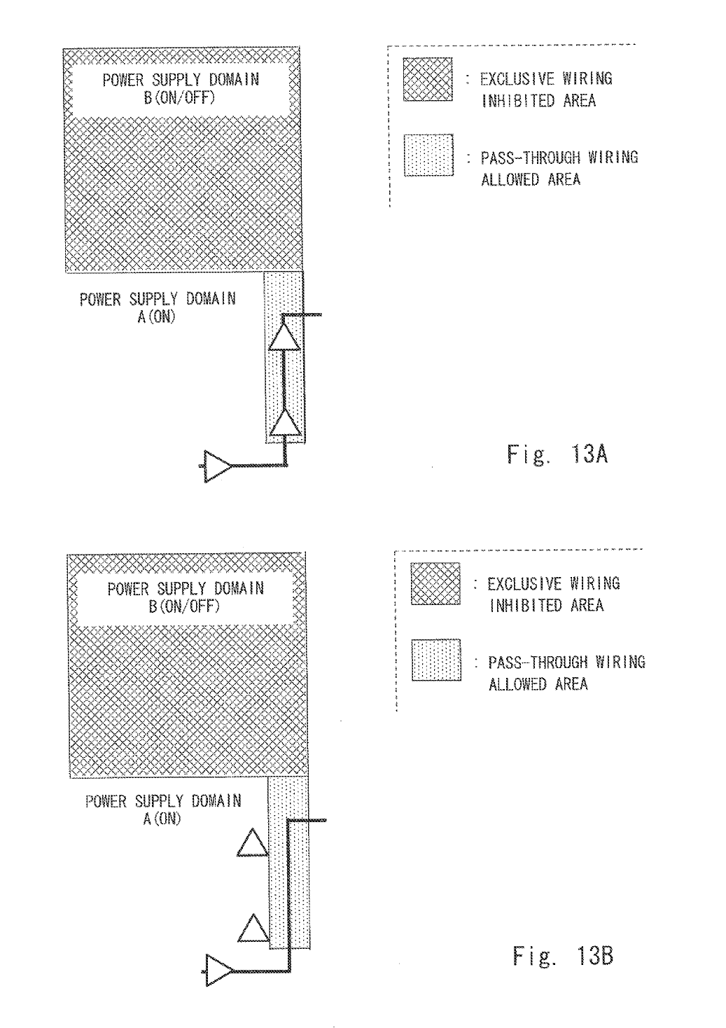

A case where the operation of a repeater buffer becomes unstable and measures against such a case are described hereinbelow. As shown in FIG. 12, when a wire with a length equal to or longer than the repeater wire maximum length exists within the pass-through wiring allowed area, the wiring setting unit 130 does not select the wire as a target or rewiring and thus the wire is left. This can cause a repeater buffer to fail to perform a desired operation. An example of measures against the problem shown in FIG. 12 is described hereinbelow.

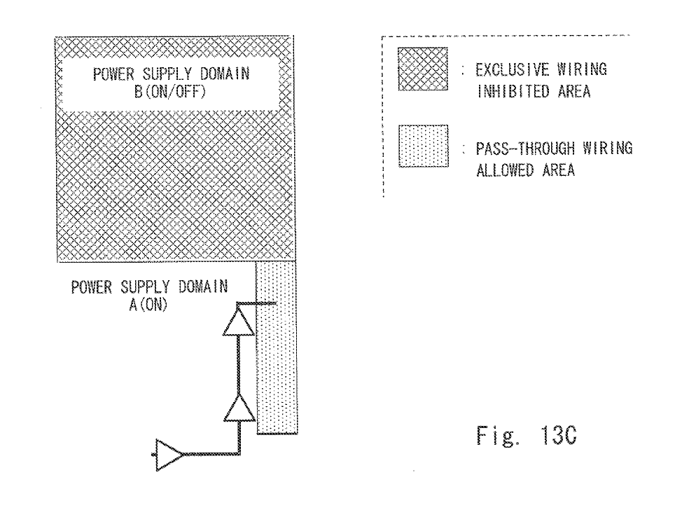

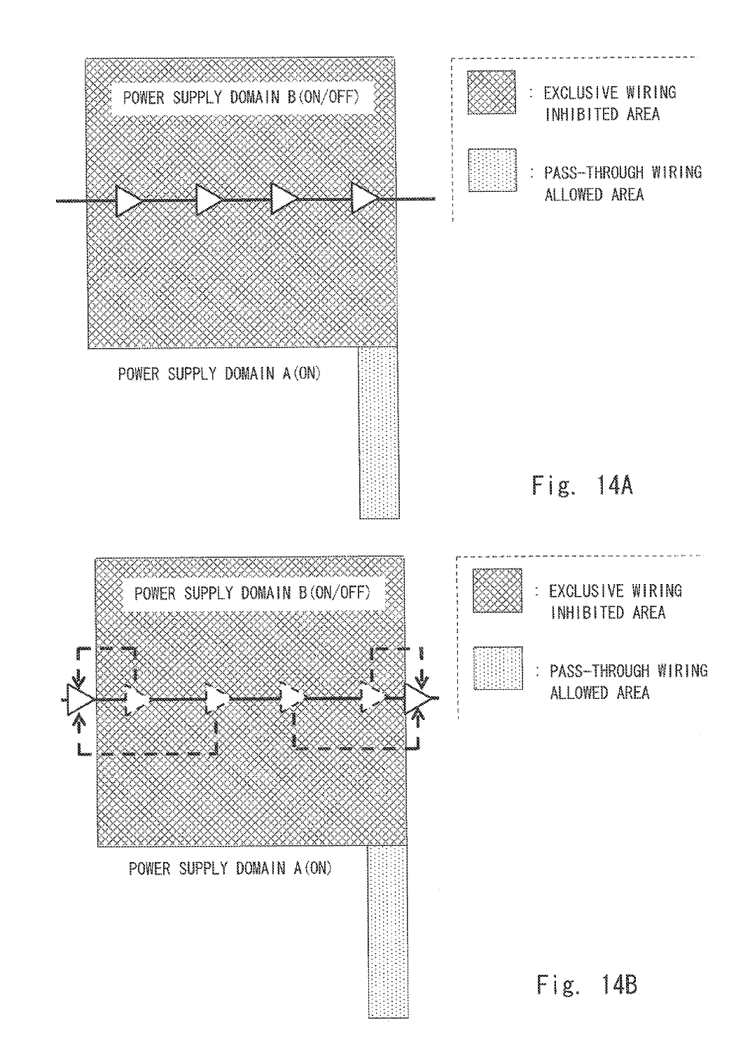

First measures are to use the function of the layout generation unit 110 (automatic placement and routing tool) having the existing function. FIGS. 13A-13C are diagrams showing the concept of the measures. FIG. 13A is a diagram showing the state where repeater buffers are placed in a different power supply domain (i.e. the power supply domain B). The layout generation unit 110 relocates the repeater buffers placed in the power supply domain B to the closest positions in the power supply domain A. FIG. 13B is a diagram showing the state where the repeater buffers placed in the power supply domain B are relocated to the closest positions in the power supply domain A. The layout generation unit 110 then decides a wire position according to the positions of the relocated repeater buffers. FIG. 13C is a diagram showing rewiring by the layout generation unit 110.

Note that it is not appropriate to take the same measures as in FIGS. 13A-13C when repeater buffers are inserted within the exclusive wiring inhibited area. The reason for this is described hereinafter with reference to FIGS. 14A-14B.

FIG. 14A is a diagram showing the state where repeater buffers are placed in the exclusive wiring inhibited area. FIG. 14B is a diagram showing the state where the repeater buffers shown in FIG. 14A are relocated to the closest positions in the power supply domain A. However, with those positions, a wiring interval that is longer than the repeater wire maximum length occurs, and it is thus not an adequate laying of a wire.

The pass-through wiring allowed area is an area including a portion with the repeater wire maximum length or less. Therefore, the problem shown in FIG. 12 can be handled by the existing function of the layout generation unit 110.

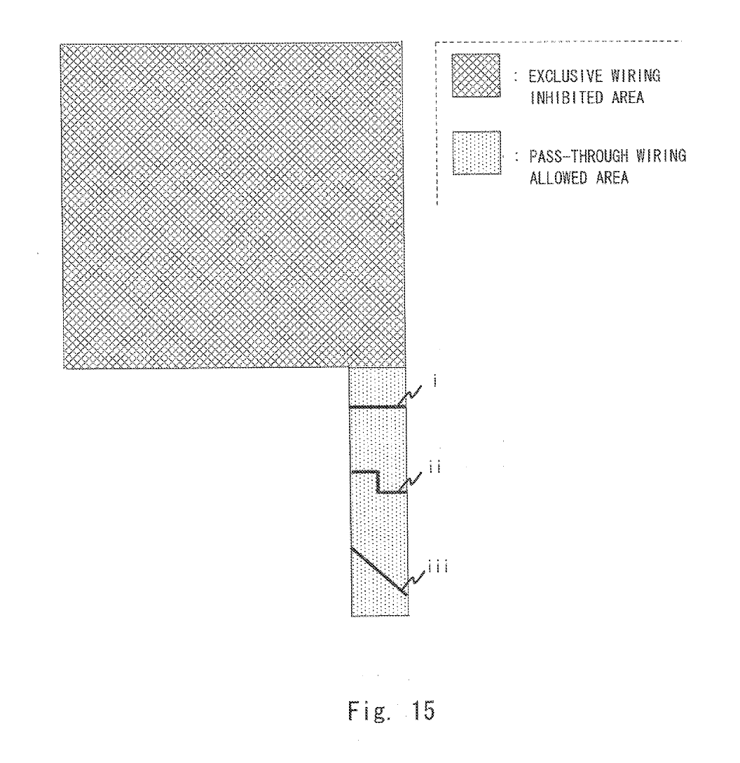

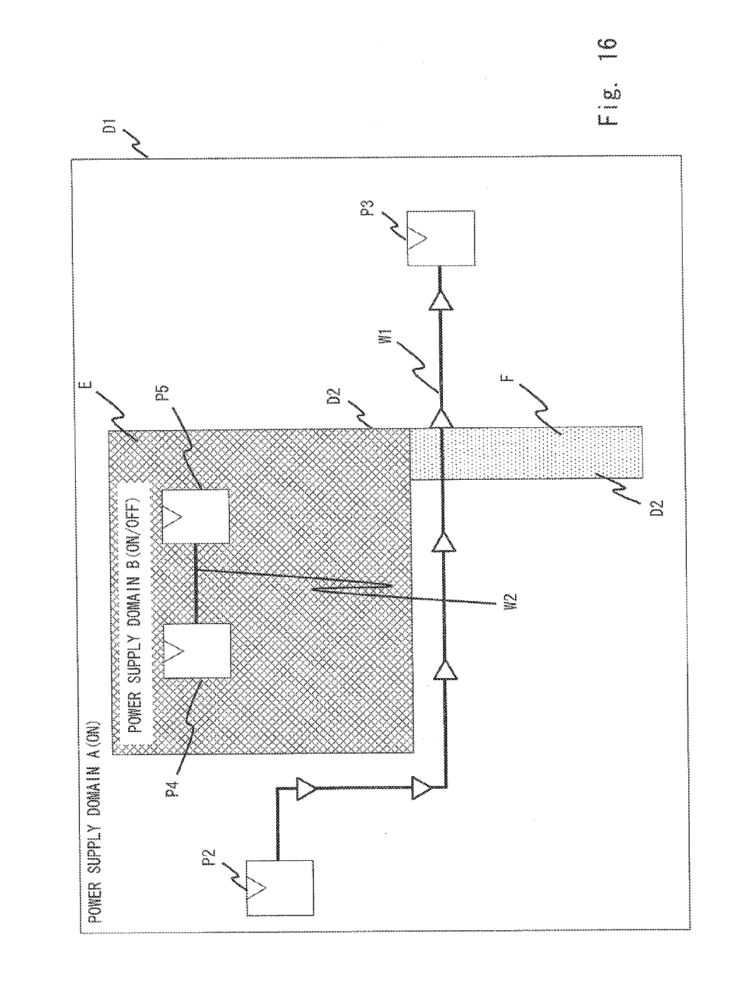

Second measures against the problem described with reference to FIG. 12 are described hereinbelow. FIG. 15 is a diagram showing the concept of the second measures. The second measures are a technique that the wiring inhibited/allowed area setting unit 120 sets a direction to allow pass-through at the time of setting the pass-through wiring allowed area.

For example, the wiring inhibited/allowed area setting unit 120 extracts a line segment (FIG. 15(i)) that is equal to or shorter than the repeater wire maximum length within the pass-through wiring allowed area, and makes setting to enable laying of a wire that overlaps the line segment (or a wire in the same direction as the direction of the line segment).

Note that the wiring inhibited/allowed area setting unit 120 may extract a line segment (FIG. 15(ii)) on a polygonal line that is equal to or shorter than the repeater wire maximum length within the pass-through wiring allowed area, and make setting to enable laying of a wire that overlaps the line segment (or a wire in the same direction as the direction of the line segment).

Generally, wiring that obliquely pass through a power supply domain is not performed. However, when the oblique wiring is taken into consideration, the wiring inhibited/allowed area setting unit 120 may extract a line segment (FIG. 15(iii)) in the oblique direction that is equal to or shorter than the repeater wire maximum length within the pass-through wiring allowed area, and make setting to enable laying of a wire that overlaps the line segment (or a wire in the same direction as the direction of the line segment).

In this manner, by setting the wiring direction along which pass-through is allowed in the pass-through wiring allowed area, it is possible to avoid the problem shown in FIG. 12 and prevent the insertion of repeater buffers within the pass-through wiring allowed area.

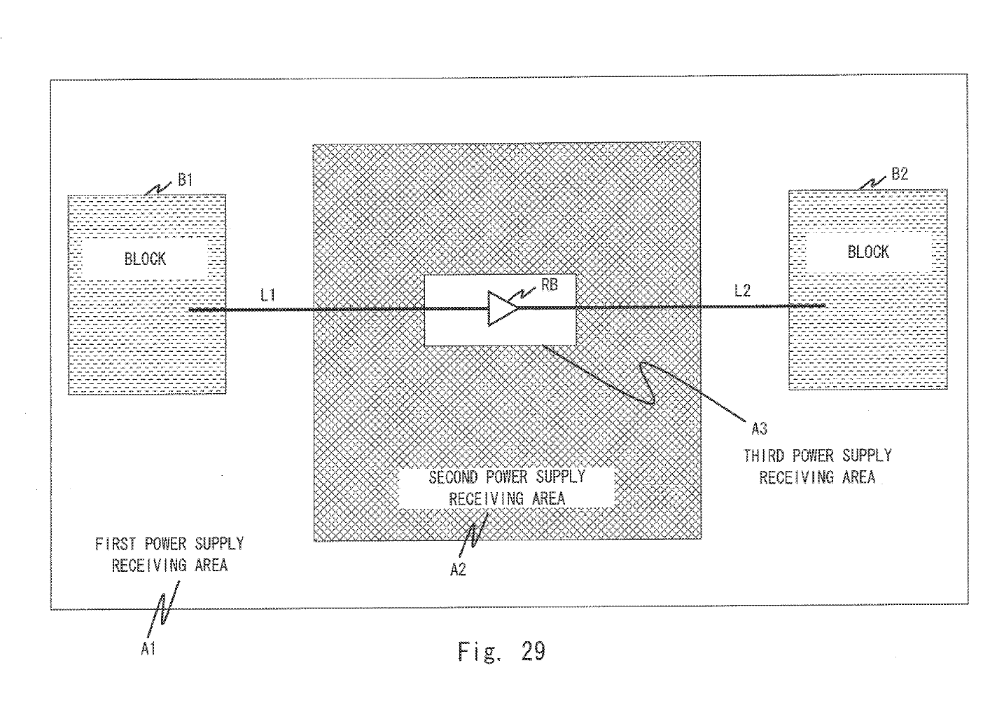

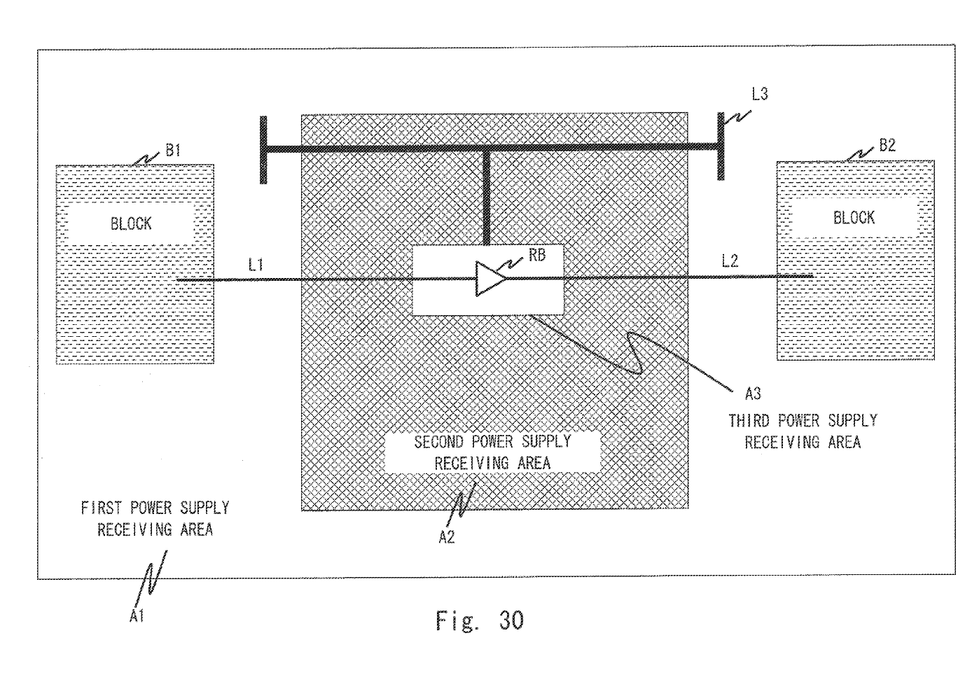

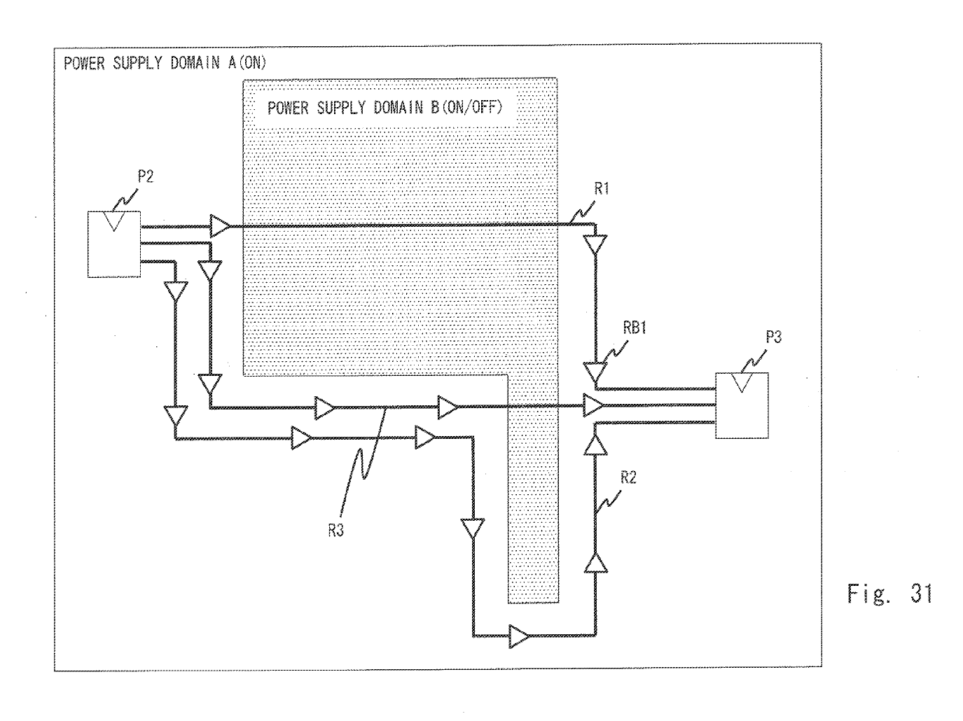

The effects of the semiconductor layout setting device and the semiconductor layout method according to this embodiment are described hereinbelow. In this embodiment, the exclusive wiring inhibited area in which wiring connecting cells in a certain power supply domain is allowed and pass-through wiring is inhibited, and the pass-through wiring allowed area in which pass-through wiring is allowed are specified on the basis of the repeater wire maximum length. In the exclusive wiring inhibited area, pass-through wiring is inhibited, and only wiring connecting primitive cells in the same power supply domain is allowed. There is thus no need to form an area for repeater buffers in the exclusive wiring inhibited area. This eliminates the need to form an additional power supply domain that is included in a certain power supply domain as shown in FIG. 29. Further, with the pass-through wiring allowed area, it is possible to lay pass-through wiring on which repeater buffer are not inserted, which eliminates the need to make wiring to detour around the power supply domain. Because it is not necessary to form an area for repeater buffers within the power supply domain as well as avoiding laying of detour wiring, it is possible to reduce the chip area and avoid the malfunction of a repeater buffer caused by a difference in power supply domain.

The effects of the semiconductor layout setting device and the semiconductor layout method according to this embodiment are described specifically with reference to FIG. 16. FIG. 16 is a diagram showing layout information that is output from the semiconductor layout setting device 100 according to this embodiment. The placement of power supply domains and the placement of primitive cells are the same as those of FIG. 3. Further, the repeater wire maximum length is 100 μm.

The wiring inhibited/allowed area setting unit 120 sets the exclusive wiring inhibited area E and the pass-through wiring allowed area F in the area of the power supply domain B (D2) by the above-described method. The wiring setting unit 130 executes the wiring modification process (S160 in FIG. 4, S161 to S165 in FIG. 8). The repeater insertion unit 140 then sets repeater buffers on the modified wiring.

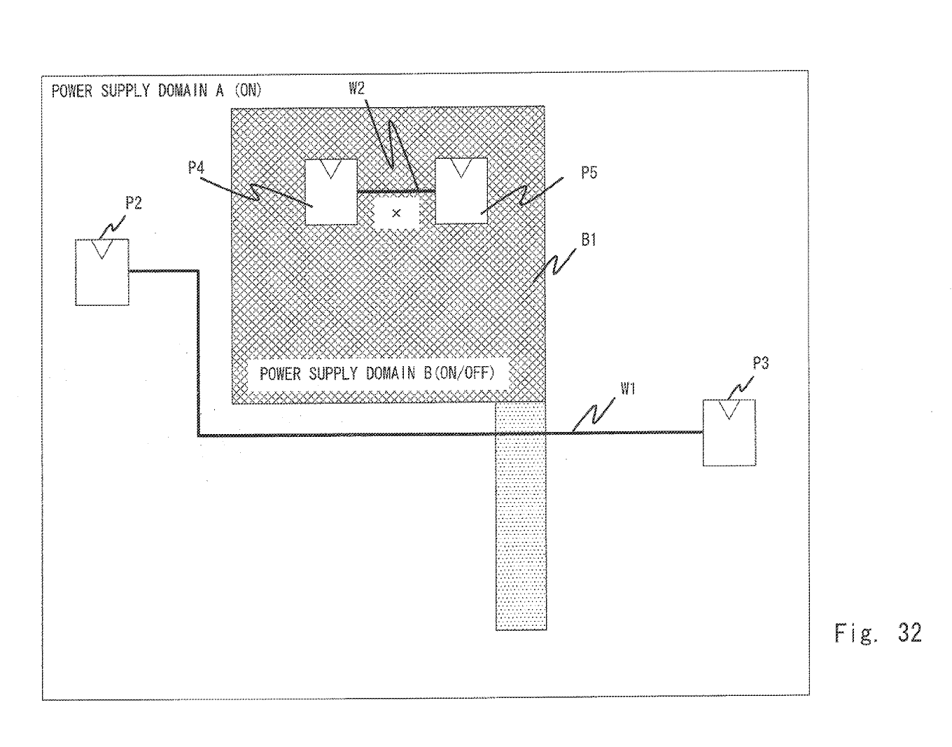

The wiring setting unit 130 excludes the wire W2 that connects the primitive cells P4 and P5 belonging to the same power supply domain (the power supply domain B) form a target of rewiring (S162 in FIG. 8). It is thereby possible to prevent the wire W2 that connects the primitive cells in the same power supply domain from being unavailable, differently from the case of setting the wiring inhibited area in FIG. 32.

The wiring setting unit 130 modifies wiring so that the wire W1 connecting the primitive cells P2 and P3 belonging to the power supply domain A is the shortest possible route that does not pass through the exclusive wiring inhibited area E (FIG. 16). In this case, the shortest possible route (the wire W1 in FIG. 16) is a route that passes through the pass-through wiring allowed area F. In this manner, it is possible to set a wire that does not detour around the power supply domain B. Further, because the pass-through wiring allowed area F has an interval with a length equal to or shorter than the repeater wire maximum length, in no case repeater buffers are inserted within the power supply domain B according to the repeater insertion method described above, thereby avoiding the occurrence of malfunction of repeater buffers.

As described above, the semiconductor layout setting device 100 according to this embodiment can achieve inhibiting detour wiring, avoiding placement of a power supply domain for repeater buffers within another power supply domain, and inhibiting wiring having a pass-through distance that is equal to or longer than the repeater wire maximum length. Therefore, the semiconductor layout setting device 100 according to this embodiment enables normal operation of repeater buffers as well as preventing an increase in chip area.

Further, the semiconductor layout setting device 100 according to this embodiment generates the above-described layout information 210 (the layout that achieves appropriate insertion of repeater buffers) only by inputting the netlist 201, the floor plan information 202 and the library 203. This eliminates the need for a user to manually modify the layout information or the like. Therefore, the semiconductor layout setting device 100 according to this embodiment further has the effect of reducing design TAT (Turn Around Time).

### Second Embodiment

A semiconductor layout setting device according to this embodiment has a feature that wiring congestion can be relieved by cutting down the corner (vertex) of the exclusive wiring inhibited area (setting it as the pass-through wiring allowed area) and providing a wiring detour area. The semiconductor layout setting device according to this embodiment is described in detail hereinafter, mainly about differences from that of the first embodiment.

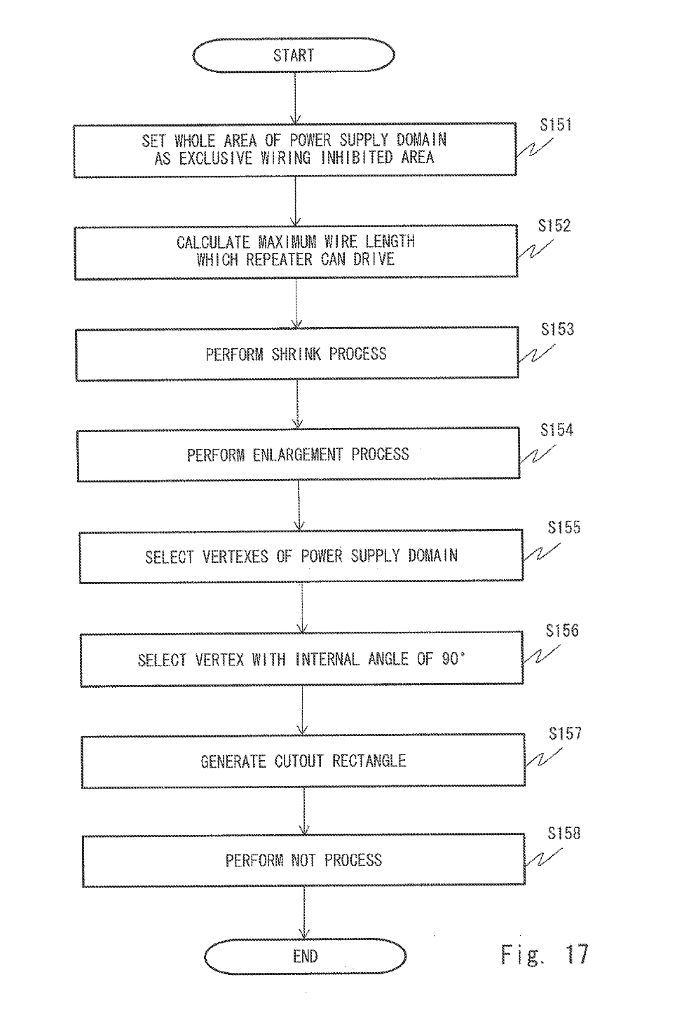

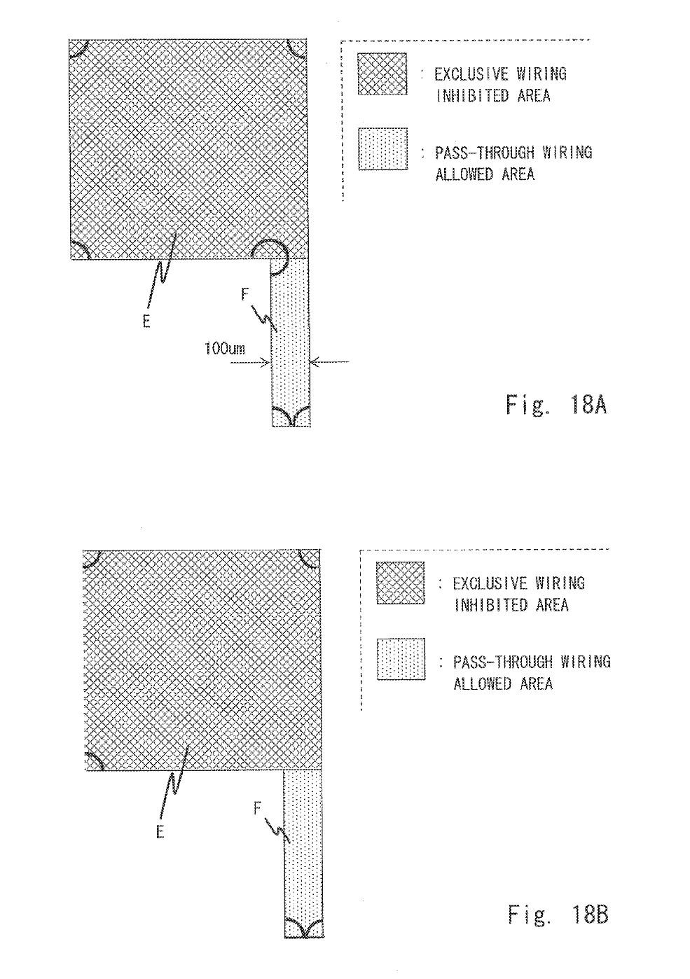

The semiconductor layout setting device 100 according to this embodiment has the same configuration as the semiconductor layout setting device 100 shown in FIG. 2. Further, the processing of each component other than the wiring inhibited/allowed area setting unit 120 is the same as that of the first embodiment. The operation of the wiring inhibited/allowed area setting unit 120 according to this embodiment is described hereinafter with reference to FIG. 17. FIG. 17 is a flowchart showing the operation of the wiring inhibited/allowed area setting unit 120 according to this embodiment.

The processes of S151 to S154 are the same as those of the first embodiment. After the enlargement process (S154), the wiring inhibited/allowed area setting unit 120 selects all of the corners, or all of the vertexes, of the power supply domain (S155).

The wiring inhibited/allowed area setting unit 120 selects the vertexes with an interior angle of 90° among the selected vertexes (S156). The wiring inhibited/allowed area setting unit 120 sets rectangles to be cut out, which are areas to be excluded from the exclusive wiring inhibited area (areas to be set as the pass-through wiring allowed area) with respect to the selected vertexes as a reference (S157). The width and height of the rectangular area is set to satisfy the following equation. Note that, when the sum of the width and height of the rectangle is set equal to the repeater wire maximum length, the size of the area to be excluded from the exclusive wiring inhibited area is the largest, which is the most effective avoidance of wiring congestion.

(Width of rectangle)+(Height of rectangle)<=Repeater wire maximum length

The wiring inhibited/allowed area setting unit 120 excludes the areas set in S157 from the exclusive wiring inhibited area; in other words, changes the areas set in S157 into the pass-through wiring allowed area (NOT process) (S158).

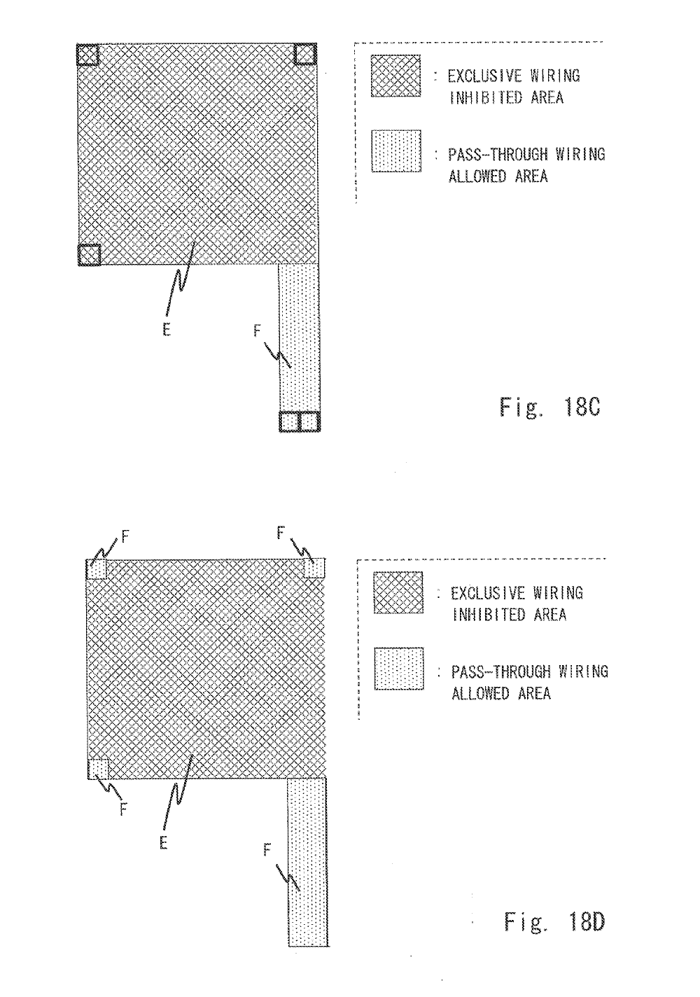

A specific example of the above-described process of S155 to S158 is described hereinafter with reference to FIGS. 18A-18D. FIGS. 18A-18D is a conceptual diagram showing a specific example of the process of the wiring inhibited/allowed area setting unit 120 according to this embodiment. In the following description, it is assumed that the repeater wire maximum length is 100 μm.

FIG. 18A is a diagram showing the state where all vertexes (six vertexes) of a power supply domain on which the enlargement process is done are selected. The wiring inhibited/allowed area setting unit 120 selects five vertexes with an interior angle of 90° among the selected vertexes (six vertexes). FIG. 18B is a diagram showing the state where only the vertexes (five vertexes) with an interior angle of 90° are selected among the selected vertexes (six vertexes).

FIG. 18C is a diagram showing the state where rectangle areas having a square shape at 50 μm are set from each of the selected vertexes. FIG. 18D is a diagram showing the state where the set rectangle areas are excluded from the exclusive wiring inhibited area; in other words, set as the pass-through wiring allowed area.

As shown in FIGS. 18A-18D, the exclusive wiring inhibited area after the process of S155 to S158 (FIG. 18D) is smaller than the exclusive wiring inhibited area after the enlargement process (FIG. 18A). Therefore, wiring flexibility thereby increases, so that the effect of relieving wiring congestion is produced. As shown in FIGS. 18A-18D, the part near the vertex of the power supply domain is changed into the pass-through wiring allowed area. The part near the vertex of the power supply domain is an area where the problem of wiring congestion is generally likely to occur. It is thus possible to effectively eliminate the wiring congestion.

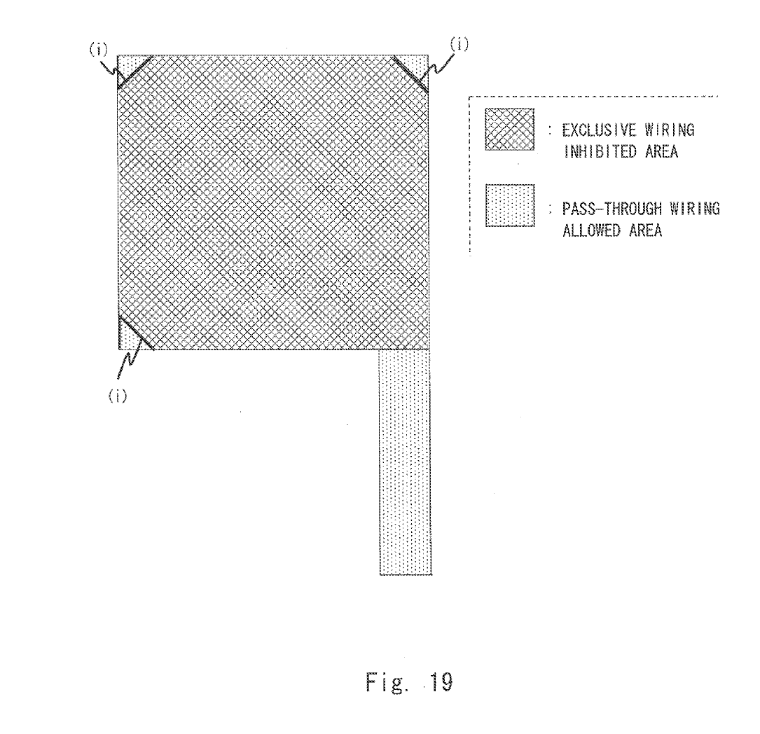

Generally, a wire is laid in parallel with any side of the power supply domain. However, in the case of allowing a wire that is not parallel with any side of the power supply domain, the shape of the area set in S157 is not necessarily a rectangle. FIG. 19 is a diagram showing an example of a cutout area other than the rectangle area. As shown in FIG. 19, the area to change into the pass-through wiring allowed area (cutout area) may be a triangle. In this case, the length obtained by subtracting the side of the outline of the power supply domain from the whole length of the outer periphery of this area (the length of a line segment (i) in FIG. 19) is set to be the repeater wire maximum length or shorter.

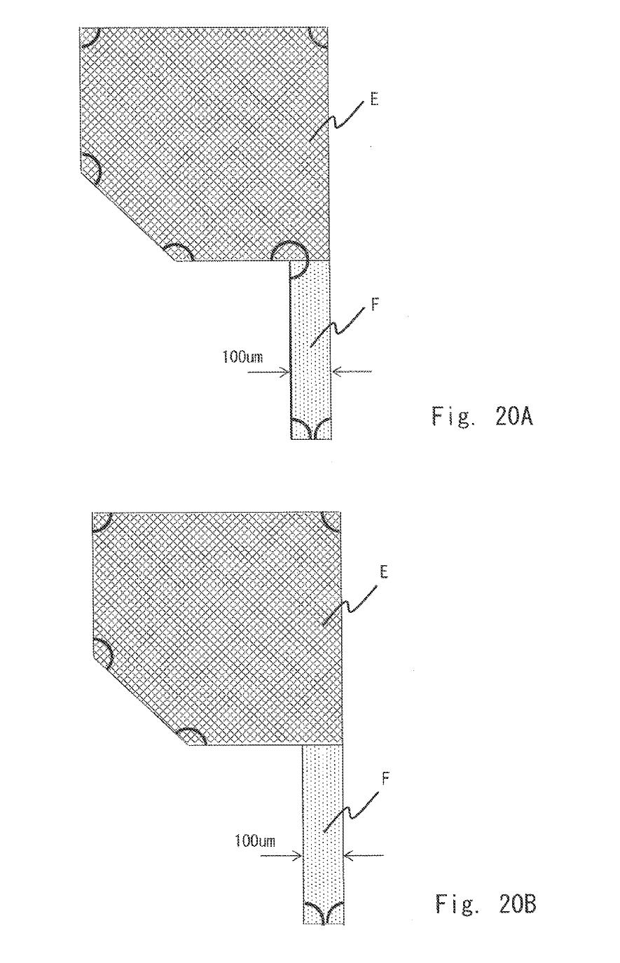

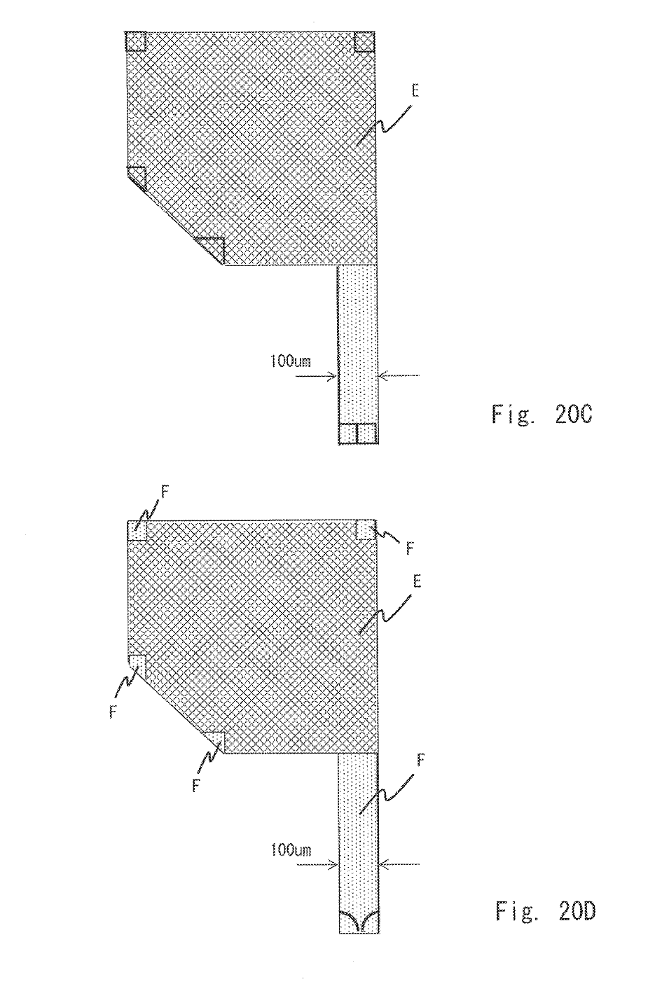

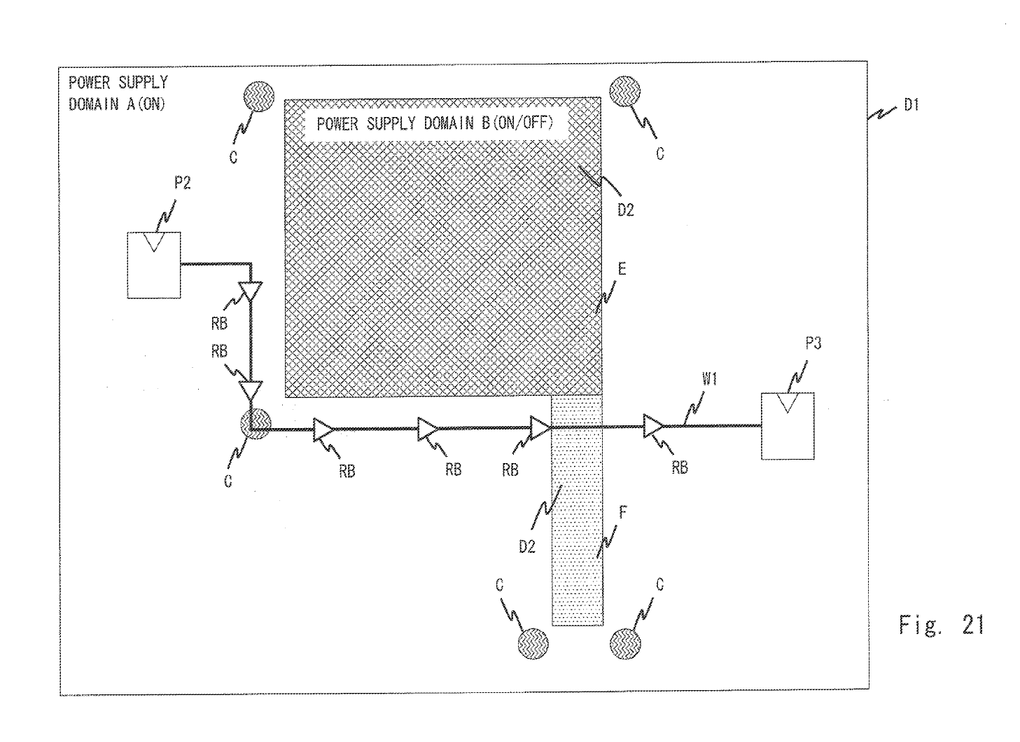

Further, the process shown in FIG. 17 is applicable to power supply domains of various shapes. Generally, the vertex of a power supply domain has an angle or 90° or 270°. However, the above technique can be applied to a power supply domain with a vertex angle different from 90° or 270°. The application to such a power supply domain is described with reference to FIGS. 20A-20D.

FIG. 20A is a diagram showing the state where all vertexes (seven vertexes) of a power supply domain on which the enlargement process is done are selected. The wiring inhibited/allowed area setting unit 120 selects six vertexes with an interior angle of less than 180° among the selected vertexes. FIG. 20B is a diagram showing the state where only the vertexes with an interior angle of less than 180° are selected among the selected vertexes.

FIG. 20C is a diagram showing the state where polygonal areas are set from each of the selected vertexes. FIG. 20D is a diagram showing the state where the set polygonal areas are excluded from the exclusive wiring inhibited area; in other words, set as the pass-through wiring allowed area.

As shown in FIGS. 20A-20D, in the case where there are various vertex angles of a power supply domain, the wiring inhibited/allowed area setting unit 120 may select vertexes with an angle of less than 180° and set areas from the selected vertexes. Further, the set area may be set so that the length obtained by subtracting the side of the outline of the power supply domain from the whole length of the outer periphery of the set area is equal to or shorter than the repeater wire maximum length. The length of the pass-through wire can be thereby equal to or shorter than the repeater wire maximum length, and the exclusive wiring inhibited area can be smaller than the area after the enlargement process.

The effects of the semiconductor layout setting device and the semiconductor layout method according to this embodiment are described hereinbelow. The wiring inhibited/allowed area setting unit 120 according to this embodiment provides an area for wiring detour by cutting down the exclusive wiring inhibited area at the corners of the power supply domain, or, changing them into the pass-through wiring allowed area. It is thereby possible to lay wiring, avoiding the portion where wiring congestion occurs at each vertex of the power supply domain.

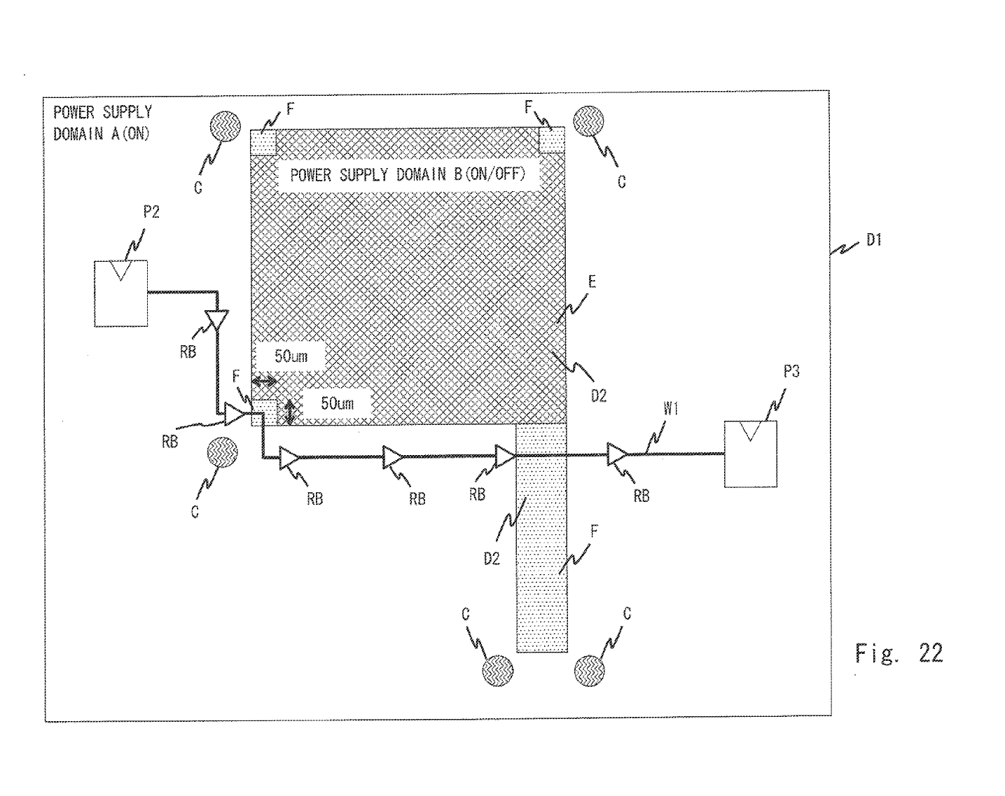

The detailed effects are described by comparison between FIGS. 21 and 22. FIG. 21 is a diagram showing the layout information that is designed by the semiconductor layout setting device 100 according to the first embodiment. In FIGS. 21 and 22, the repeater wire maximum length is 100 μm.

As shown in FIG. 21, the area of the power supply domain A (D1) and the area of the power supply domain B (D2) are set. The power supply domain A maintains the state where power supply is always ON, which means that a power is always supplied to the power supply domain A. On the other hand, a power to a power supply domain B is cut off (OFF) when an internal circuit does not operate. The primitive cells P2 and P3 are placed within the area of the power supply domain A (D1). The wire W1 connects the primitive cells P2 and P3. A repeater RB is a repeater buffer that is placed on the wire W1. The exclusive wiring inhibited area E and the pass-through wiring allowed area F are set in the area of the power supply domain B (D2). An area C (wiring congestion area C) is an area where wiring congestion occurs in the vicinity of each vertex of the power supply domain B.

Because the wire W1 is laid to go through the outside of the exclusive wiring inhibited area E, the shortest possible route passes through the wiring congestion area C. This makes wiring congestion worse. To relieve wiring congestion, it is necessary to increase the chip size.

FIG. 22 is a diagram showing the layout information that is designed by the semiconductor layout setting device 100 according to this embodiment. The placement of power supply domains, the placement of primitive cells, and the positions of the wiring congestion areas C are the same as those of FIG. 21.

As shown in FIG. 22, the pass-through wiring allowed area F having a square shape of 50 μm on each side is provided at the vertex with an interior angle of 90° of the area of the power supply domain B (D2). The area can serve as a wiring detour area.

The wire W1 passes through the area that has been cut off from the exclusive wiring inhibited area E (the area that has changed from the exclusive wiring inhibited area E to the pass-through wiring allowed area F) as shown in FIG. 22. The wire W1 thereby detours around the wiring congestion area C. Although the wire W1 passes through the power supply domain B when detouring around the wiring congestion area C, the length of the pass-through wire is 100 μm or less (which is the repeater wire maximum length or less). Therefore, it is not necessary to insert a repeater within the power supply domain B. In this manner, because the area of the exclusive wiring inhibited area E is smaller than that of the first embodiment, and wiring can be set to detour around the wiring congestion area C, it is possible to prevent an increase in chip size.

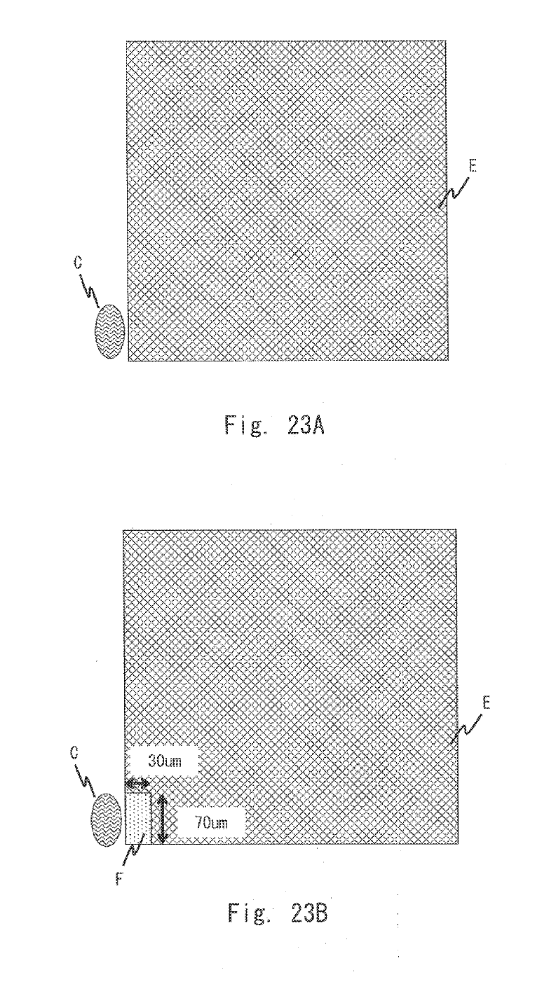

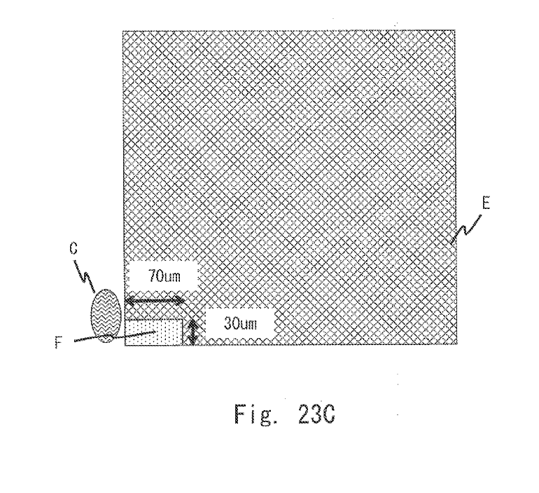

Note that the wiring inhibited/allowed area setting unit 120 may specify the shape of a rectangular area that is set in S157 in consideration of wiring congestion conditions. This is described in detail with reference to FIGS. 23A-23C. FIGS. 23A-23C are conceptual diagrams showing one technique to set the shape of a rectangular area.

FIG. 23A is a diagram showing the state where the vertically elongated wiring congestion area C exists in the vicinity of a given vertex of the power supply domain. Note that the shape of the wiring congestion area C can be calculated from a result of the wiring process by the wiring unit 114.

Assume that the wiring inhibited/allowed area setting unit 120 has set a vertically elongated rectangular area as shown in FIG. 23B. In this case, a wire is likely to be laid at the position near the wiring congestion area C. The wire laid within the wiring congestion area C can be thereby easily relocated horizontally. In other words, the possibility that the wire within the wiring congestion area C can be relocated to the outside of the range of the area C increases.

On the other hand, assume that the wiring inhibited/allowed area setting unit 120 has set a horizontally elongated rectangular area as shown in FIG. 23C. In this case, it is difficult to relocate a wire laid within the wiring congestion area C to the horizontally elongated rectangular area.

In this manner, the wiring inhibited/allowed area setting unit 120 can set the rectangular area (the area to change from the exclusive wiring inhibited area E to the pass-through wiring allowed area F) in consideration of the wiring congestion area C, so that wiring congestion can be avoided more effectively. Specifically, it is effective that the wiring inhibited/allowed area setting unit 120 specifies the rectangular area as close as possible to the wiring congestion area C as shown in FIG. 23B.

### Other Embodiments

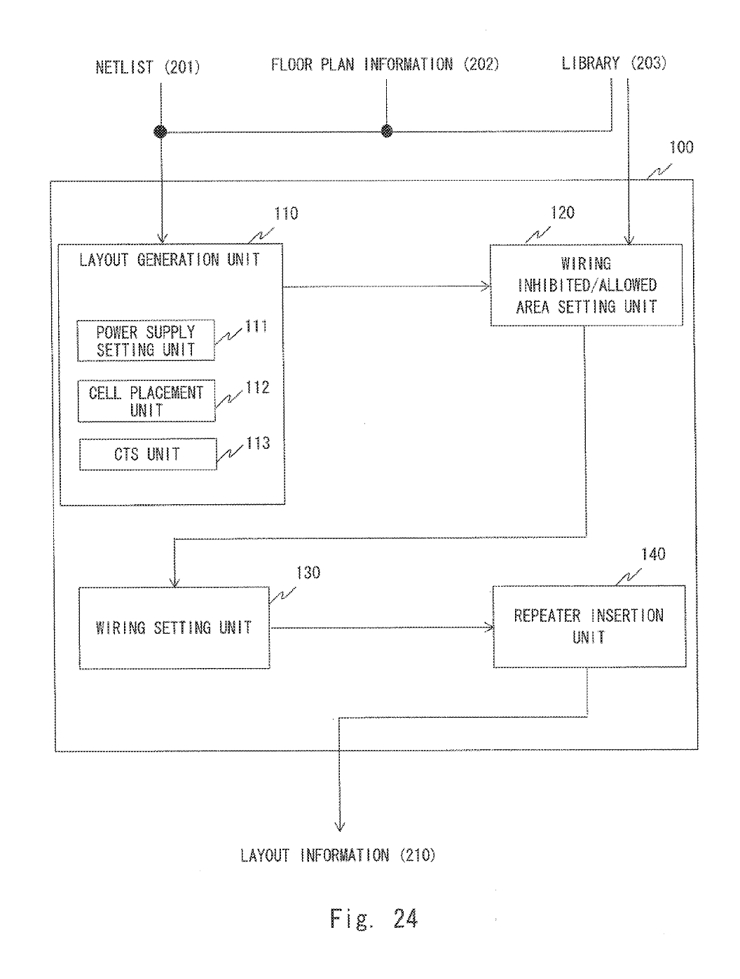

Alternative examples of the semiconductor layout setting device according to the first or second embodiment are described hereinbelow. The semiconductor layout setting device 100 shown in FIG. 24 does not have the wiring unit inside the layout generation unit 110 and has the wiring setting unit 130 outside the layout generation unit 110. The wiring setting unit 130 performs the wiring process for all wires after setting of the exclusive wiring inhibited area by the wiring inhibited/allowed area setting unit 120. Note that the setting of the exclusive wiring inhibited area and the insertion of repeater buffers may be performed in the same manner as described above. The wiring process may be made by selecting the shortest possible route that allows passing through only the pass-through allowed area for the wire that passes through the power supply domain.

As described above, the same effects as in the first and second embodiments can be obtained also in the case of performing the wiring process after setting the exclusive wiring inhibited area.

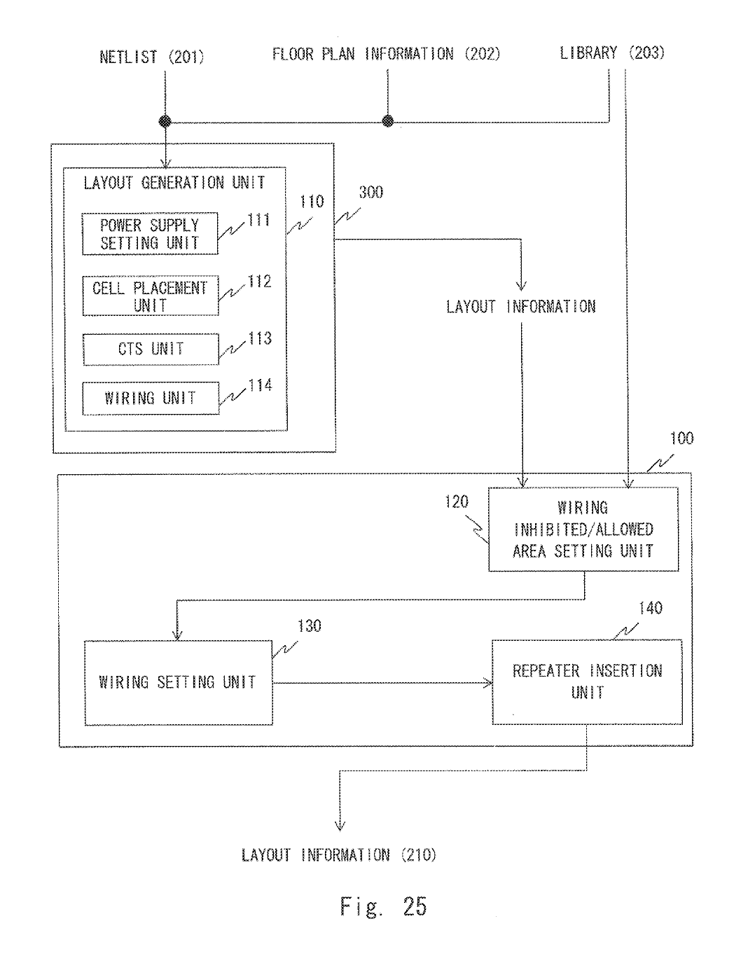

Further, as shown in FIG. 25, the above-described layout generation unit 110 and the other units (the wiring inhibited/allowed area setting unit 120, the wiring setting unit 130 and the repeater insertion unit 140) may be incorporated in different devices. A device 300 is configured as a separate device from the semiconductor layout setting device 100. The library 203 is supplied, in addition to the layout information generated by the device 300, to the semiconductor layout setting device 100. Note that the operation of each unit is the same as described above. In this configuration also, the same effects as in the first and second embodiments can be obtained.

It should be noted that the present invention is not restricted to the above-described embodiments. The elements of the above-described embodiments are susceptible of various changes, additions and transformations as known to those skilled in the art within the scope of the invention.

For example, a plurality of power supply domains with different driving voltages which always maintains ON state may be treated as different power supply domains.

Further, although wiring in the layout in which the power supply domain A includes the power supply domain B is described in the above example, it is not limited thereto. For example, the above-described layout setting method may be applied to the case where the power supply domain A and the power supply domain B are adjacent to each other.

Although the above description is based on the assumption that repeater buffers are inserted on a wire, the present invention is not limited thereto. For example, the layout setting method of the present invention may be applied also to the case of inserting inverters instead of the repeater buffers described above.

The processing of the units (the layout generation unit 110, the wiring inhibited/allowed area setting unit 120, the wiring setting unit 130 and the repeater insertion unit 140) shown in FIG. 2, 24 or 25 can be implemented as a program operating on a given computer. The program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

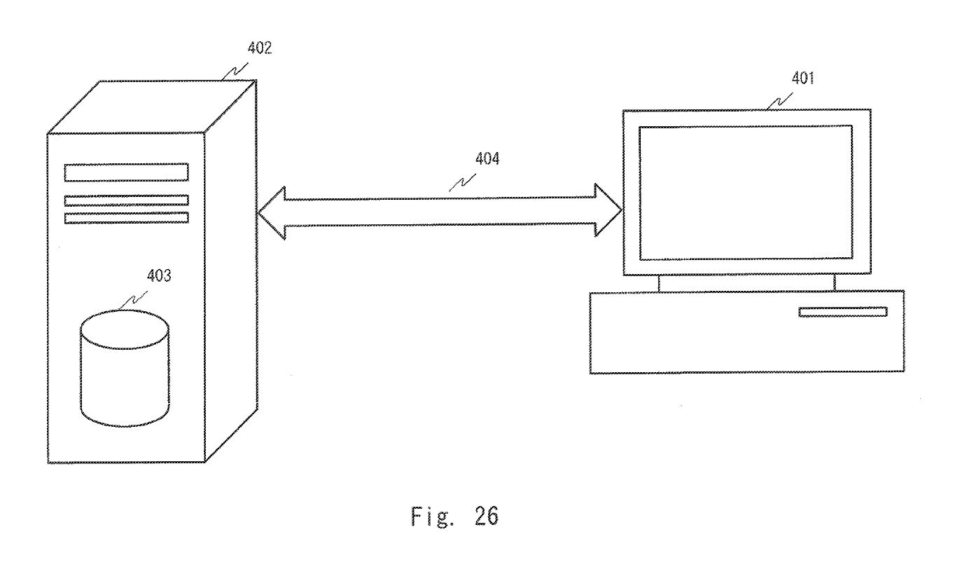

FIG. 26 is a diagram showing one aspect of a system configuration in the case of executing each processing of the above-described semiconductor layout setting method (each processing of the layout generation unit 110, the wiring inhibited/allowed area setting unit 120, the wiring setting unit 130 and the repeater insertion unit 140) as a program.

The system includes a computer device 401 and a server 402. The server 402 includes a storage medium 403. The computer device 401 is an engineering station, for example. The computer device 401 and the server 402 are connected through a network 404 (for example, Internet). The storage medium 403 stores an execution program for executing the above-described processing (each processing of the layout generation unit 110, the wiring inhibited/allowed area setting unit 120, the wiring setting unit 130 and the repeater insertion unit 140).

The computer device 401 downloads the execution program for semiconductor layout setting stored in the storage medium 403 through the network 404. The downloaded program is stored in a local hard disk, memory or the like within the computer device 401 and executed.

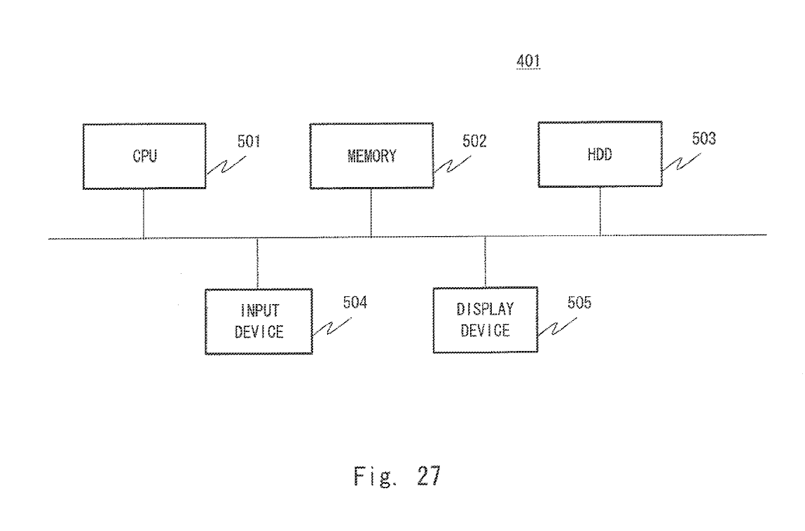

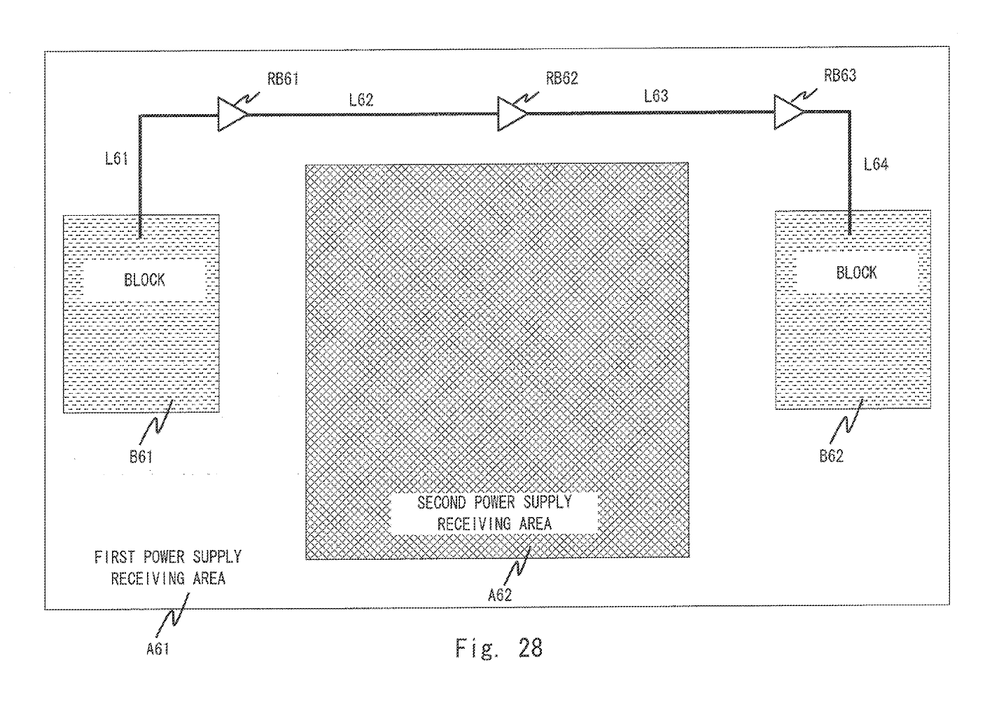

FIG. 27 shows an example of the hardware configuration of the computer device 401. The computer device 401 includes a central processing unit (CPU) 501 and a memory 502. The CPU 501 and the memory 502 are connected to a hard disk device (HDD) 503 which serves as an auxiliary storage device through a bus. The computer device 401 typically has user interface hardware. The user interface hardware includes an input device 504 such as a pointing device (mouse, joystick etc.) and a keyboard for input, and a display device 505 such as a liquid crystal display for presenting visual data to a user, for example. A computer program that gives instructions to the CPU 501 or the like in coordination with an operating system to perform the above-described semiconductor layout setting process may be stored in a storage medium of the hard disk device 503 or the like.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first and second embodiments can be combined as desirable by one of ordinary skill in the art.

What is claimed is:

1. A semiconductor layout setting device comprising:
a wiring inhibited/allowed area setting unit that, in a layout of a semiconductor device having first and second power supply domains, sets an exclusive wiring inhibited area and a pass-through wiring allowed area within the first power supply domain based on a repeater wire maximum length being a maximum wire length which a repeater buffer can drive;
a wiring setting unit that sets a position of a wire based on the exclusive wiring inhibited area and the pass-through wiring allowed area; and
a repeater insertion unit that sets a repeater buffer to be inserted on a wire based on each position of a wire and the repeater wire maximum length, wherein
the exclusive wiring inhibited area is an area where wiring connecting cells within the first power supply domain is allowed and pass-through wiring is inhibited, and
the pass-through wiring allowed area, being an area obtained by excluding the exclusive wiring inhibited area from the first power supply domain, is an area where pass-through wiring is allowed.

2. The semiconductor layout setting device according to claim 1, wherein the wiring inhibited/allowed area setting unit sets the exclusive wiring inhibited area by setting a whole area of the first power supply domain as an area where pass-through wiring is inhibited, shrinking the area by a size of a first width based on the repeater wire maximum length from an outline of the first power supply domain, and enlarging the outline of the shrunk area by a size of the first width.

3. The semiconductor layout setting device according to claim 2, wherein the first width is ½ of the repeater wire maximum length.

4. The semiconductor layout setting device according to claim 1, wherein the repeater insertion unit decides to insert a repeater buffer to serve as a reference at a position on a boundary with the pass-through wiring allowed area and belonging to the second power supply domain, and decides to insert another repeater buffer with respect to the repeater buffer and the repeater wire maximum length as a reference.

5. The semiconductor layout setting device according to claim 1, wherein
a temporary wiring process is done on the layout upon input to the wiring inhibited/allowed area setting unit, and
the wiring setting unit eliminates a wire passing through the exclusive wiring inhibited area and specifies an alternative wire as an alternative to the eliminated wire so as not to pass through the exclusive wiring inhibited area.

6. The semiconductor layout setting device according to claim 1, wherein
the wiring inhibited/allowed area setting unit selects a vertex of the first power supply domain with an interior angle of 180° or less and changes a set area set based on the selected vertex from the exclusive wiring inhibited area to the pass-through wiring allowed area, and
a length obtained by subtracting a length contained in an outline of the first power supply domain from a whole length of an outline of the set area is equal to or less than the repeater wire maximum length.

7. The semiconductor layout setting device according to claim 6, wherein the wiring inhibited/allowed area setting unit selects a vertex of the first power supply domain with an interior angle of 90° and changes a rectangular area with a second width and a first height from the selected vertex as the set area from the exclusive wiring inhibited area to the pass-through wiring allowed area.

8. The semiconductor layout setting device according to claim 7, wherein a sum of the second width and the first height is equal to or less than the repeater wire maximum length.

9. The semiconductor layout setting device according to claim 7, wherein the wiring inhibited/allowed area setting unit sets a shape of the rectangular area in accordance with a position of a wiring congestion area where wiring is congested.

10. The semiconductor layout setting device according to claim 9, wherein the wiring inhibited/allowed area setting unit sets a shape of the rectangular area so that a distance from the wiring congestion area is closer.

11. The semiconductor layout setting device according to claim 1, further comprising:
a layout generation unit that generates the layout to be supplied to the wiring inhibited/allowed area setting unit.

12. The semiconductor layout setting device according to claim 11, wherein the layout generation unit relocates each repeater buffer placed within the pass-through wiring allowed area to a closest position in the second power supply domain and performs rewiring in accordance with the position of the relocated repeater buffer.

13. The semiconductor layout setting device according to claim 1, wherein the wiring inhibited/allowed area setting unit sets a direction along which wiring is possible in the pass-through wiring allowed area based on the repeater wire maximum length.

14. The semiconductor layout setting device according to claim 1, wherein the wiring inhibited/allowed area setting unit sets an area obtained by excluding a protrusion area in which a distance between opposed sides is equal to or less than the repeater wire maximum length from the first power supply domain as the exclusive wiring inhibited area.

15. A layout setting method of a semiconductor device that has first and second power supply domains and sets wiring connected to and connected from cells in the second power supply domain, comprising:
setting a layout to allow that a pass-through distance of the wiring passing through the first power supply domain is less than a maximum wire length which a repeater buffer can drive and inhibit that the pass-through distance is equal to or more than the maximum wire length.

16. The layout setting method of a semiconductor device according to claim 15, wherein
an exclusive wiring inhibited area where wiring connecting cells within the first power supply domain is allowed and pass-through wiring is inhibited, and a pass-through wiring allowed area being an area obtained by excluding the exclusive wiring inhibited area from the first power supply domain where pass-through wiring is allowed are set based on the maximum wire length.

17. The layout setting method of a semiconductor device according to claim 16, wherein the exclusive wiring inhibited area is set by setting a whole area of the first power supply domain as an area where pass-through wiring is inhibited, shrinking the area by a size of a first width based on the repeater wire maximum length from an outline of the first power supply domain, and enlarging the outline of the shrunk area by a size of the first width.

18. The layout setting method of a semiconductor device according to claim 17, wherein the first width is ½ of the repeater wire maximum length.

19. A non-transitory computer readable medium storing a semiconductor layout setting program causing a computer to execute a process of setting a layout of a semiconductor device having first and second power supply domains and having wiring connected to and connected from cells in the second power supply domain, the program causing the computer to execute:
a process of setting a layout to allow that a pass-through distance of the wiring passing through the first power supply domain is less than a maximum wire length which a repeater buffer can drive and inhibit that the pass-through distance is equal to or more than the maximum wire length.
